(19) United States
(12) Patent Application Publication
(10) Pub. No.: US 2026/0138018 A1
(43) Pub. Date: May 21, 2026

(54) ELECTRONIC DEVICE, METHOD, AND COMPUTER-READABLE STORAGE MEDIUM FOR SCANNING OBJECT IN VIRTUAL SPACE

(71) Applicant: NCSOFT Corporation, Seoul (KR)

(72) Inventors: Boyun KANG, Seongnam-si (KR); Kyeongdae Kim, Seongnam-si (KR); Munsu Kim, Seongnam-si (KR); Taeeun Kim, Seongnam-si (KR); Junghyun Lee, Seongnam-si (KR); Joowon Lee, Seongnam-si (KR); Sunggoo Heo, Seongnam-si (KR)

(73) Assignee: NCSOFT Corporation, Seoul (KR)

(21) Appl. No.: 19/450,071

(22) Filed: Jan. 15, 2026

Related U.S. Application Data
(63) Continuation of application No. PCT/KR2023/012344, filed on Aug. 21, 2023.

(51) Int. Cl. A63F 13/5372; A63F 13/525; A63F 13/69

(52) U.S. Cl. CPC A63F 13/5372; A63F 13/525; A63F 13/69

(57) ABSTRACT

An electronic device includes a display, memory, and processor configured to display a screen with a virtual space including a player character (PC) and objects, with a sphere-shaped button for scanning target objects; display, upon detecting a pan input on the button, a user interface with a sphere-shaped visual object surrounding the PC and an indicator showing a first direction from a reference location; display the indicator showing a second direction changed from the first direction based on pan input movement; and display visually highlighted target objects within a range from a scan location identified based on the second direction upon detecting release of the pan input. The system provides visual guidance including progress bars, directional indicators, and coordinate-based direction definitions for intuitive object scanning in virtual environments.

### CROSS-REFERENCE TO RELATED APPLICATIONS

This application is a by-pass continuation application of International Application No. PCT/KR2023/012344, filed on Aug. 21, 2023, the disclosures of which is incorporated by reference herein in its entirety.

### FIELD

Embodiments disclosed in the present disclosure relate to an electronic device, a method, and a computer-readable storage medium for scanning an object in a virtual space.

### BACKGROUND

An electronic device may provide a virtual space including a character corresponding to a user. For example, the character may include a player character (PC). For example, the virtual space may be displayed through a display of the electronic device.

### SUMMARY

According to an aspect of the disclosure, an electronic device includes a display; at least one memory configured to store at least one program; at least one processor configured to operate as instructed by the program, wherein the program is configured to cause the at least one processor to display, via the display, a screen including a virtual space including a player character (PC) corresponding to a user of the electronic device and at least one object, wherein the screen includes a sphere-shaped button for scanning a target object from the at least one object; display, based on detecting a pan input on the sphere-shaped button, a user interface (UI) for guiding the scanning, wherein the UI includes a sphere-shaped visual object surrounding the PC and an indicator indicating a first direction extending from a reference location corresponding to the PC in the virtual space; display, based on movement of the pan input while the UI is displayed, the indicator indicating a second direction changed from the first direction; and display, based on detecting release of the pan input, at least one visually highlighted target object within a range from a scan location in the virtual space, wherein the scan location is identified based on the second direction.

The electronic device may include wherein a direction of the indicator, including the first direction and the second direction, is defined based on a first coordinate of a plane in the virtual space, the plane including the reference location; and a second coordinate on a vertical axis to the plane; wherein the first direction is identified based on a location of the pan input within the sphere-shaped button at a timing of detecting the pan input; and wherein the second direction is identified based on a changed location of the pan input within the sphere-shaped button resulting from the movement.

The electronic device may include wherein the program is further configured to cause the at least one processor to display, based on detecting the pan input, the UI further including an icon, the icon indicating the scan location on the indicator; and display, based on an input time interval of the pan input while the UI is displayed, the icon with the scan location that is changed from the reference location.

The electronic device may include wherein the program is further configured to cause the at least one processor to display, based on detecting the release of the pan input, a visual effect extending from the scan location along the second direction to the range.

The electronic device may include wherein the visual effect is configured to identify the target object from among the at least one object.

The electronic device may include wherein the screen further includes a bar-shaped visual object, the bar-shaped visual object extending vertically from the scan location to a point on a plane in the virtual space, the plane including the reference location, wherein the scan location is changed based on the input time interval.

The electronic device may include wherein the screen further includes a circular visual object that includes a point on the plane in the virtual space, wherein the point represents an orthogonal projection of the scan location onto the plane, the plane including the reference location, wherein the scan location is changed based on the input time interval.

The electronic device may include wherein the program is further configured to cause the at least one processor to based on identifying a second timing after a time interval from a first timing detecting the pan input, display a circular progress bar on the screen, the circular progress bar starting from a point distant from a periphery of the sphere-shaped button, and extending along the periphery; and wherein the circular progress bar is changed based on a time length from the second timing to a third timing, the third timing corresponding to detecting the release of the pan input.

The electronic device may include wherein the sphere-shaped button includes a first guide line, a second guide line different from the first guide line, and a guide point representing an intersection of the first guide line and the second guide line, and wherein the sphere-shaped visual object includes a third guide line and a fourth guide line different from the third guide line, wherein the first guide line, the second guide line, and the guide point are changed based on the movement of the pan input, and wherein the third guide line and the fourth guide line are changed to correspond with the indicator as the indicator changes based on the movement of the pan input.

The electronic device may include wherein the screen further includes an additional visual object representing a location of the pan input.

The electronic device may include wherein the program is further configured to cause the at least one processor to display, before detecting the pan input, the screen including the sphere-shaped button with a first shape; display, based on detecting the pan input, the screen including the sphere-shaped button with a second shape that is changed from the first shape; and display, based on detecting the release of the pan input, the screen including the sphere-shaped button with the first shape that is changed from the second shape.

The electronic device may include wherein the processor is configured to identify a third direction changed from the first direction during a first time interval; and identify the second direction changed from the third direction during a second time interval after the first time interval, wherein, based on a length of the first time interval being equal to a length of the second time interval, an amount of change between the third direction and the first direction is greater than an amount of change between the third direction and the second direction.

According to another aspect of the disclosure, a method executed by an electronic device includes displaying, via a display, a screen including a virtual space including a player character (PC) corresponding to a user of the electronic device and at least one object, wherein the screen includes a sphere-shaped button for scanning a target object from the at least one object; displaying, based on detecting a pan input on the sphere-shaped button, a user interface (UI) for guiding the scanning, wherein the UI includes a sphere-shaped visual object surrounding the PC and an indicator indicating a first direction extending from a reference location corresponding to the PC in the virtual space; displaying, based on movement of the pan input while the UI is displayed, the indicator indicating a second direction changed from the first direction; and displaying, based on detecting release of the pan input, at least one visually highlighted target object within a range from a scan location in the virtual space, wherein the scan location is identified based on the second direction.

The method may include wherein a direction of the indicator, including the first direction and the second direction, is defined based on a first coordinate of a plane in the virtual space, the plane including the reference location; and a second coordinate on a vertical axis to the plane; wherein the first direction is identified based on a location of the pan input within the sphere-shaped button at a timing of detecting the pan input; and wherein the second direction is identified based on a changed location of the pan input within the sphere-shaped button resulting from the movement.

The method may include displaying, based on detecting the pan input, the UI further including an icon, the icon indicating the scan location on the indicator; and displaying, based on an input time interval of the pan input while the UI is displayed, the icon with the scan location that is changed from the reference location.

The method may include displaying, based on detecting the release of the pan input, a visual effect extending from the scan location along the second direction to the range.

The method may include wherein the visual effect identifies the target object from the at least one object.

The method may include wherein the screen further includes a bar-shaped visual object, the bar-shaped visual object extending vertically from the scan location to a point on a plane in the virtual space, the plane including the reference location, wherein the scan location is changed based on the input time interval.

The method may include wherein the screen further includes a circular visual object that includes a point on the plane in the virtual space, wherein the point represents an orthogonal projection of the scan location onto the plane, the plane including the reference location, wherein the scan location is changed based on the input time interval.

According to another aspect of the disclosure, a computer-readable storage medium storing one or more programs, wherein the one or more programs comprise instructions which, when executed by a processor of an electronic device, cause the electronic device to display, via a display, a screen including a virtual space including a player character (PC) corresponding to a user of the electronic device and at least one object, wherein the screen includes a sphere-shaped button for scanning a target object from the at least one object; display, based on detecting a pan input on the sphere-shaped button, a user interface (UI) for guiding the scanning, wherein the UI includes a sphere-shaped visual object surrounding the PC and an indicator indicating a first direction extending from a reference location corresponding to the PC in the virtual space; display, based on movement of the pan input while the UI is displayed, the indicator indicating a second direction changed from the first direction; and display, based on detecting release of the pan input, at least one visually highlighted target object within a range from a scan location in the virtual space, wherein the scan location is identified based on the second direction.

### BRIEF DESCRIPTION OF THE DRAWINGS

To describe technical solutions of embodiments of this application or related technologies more clearly, the following briefly introduces the accompanying drawings required for describing embodiments or related technologies. Clearly, the accompanying drawings in the following descriptions show only some embodiments of this application, and a person of ordinary skill in the art may still derive other drawings based on these accompanying drawings without creative efforts.

FIG. 1 is an exemplary block diagram of an electronic device in a network environment, according to an embodiment.

FIG. 2 illustrates an example of a method of scanning an object located on a plane of a virtual space, according to an embodiment.

FIG. 3 illustrates an example of a method of scanning an object located on a plane of a virtual space and an object located above the plane, according to an embodiment.

FIGS. 4A to 4C illustrate an example of a method of performing a three-dimensional scan based on an input to a button for a scan, according to an embodiment.

FIG. 5 illustrates an example of an operation flow for a method of performing a three-dimensional scan based on an input to a button for a scan, according to an embodiment.

FIG. 6A illustrates an example of a method of displaying a visual object for guiding a scan location, according to an embodiment.

FIG. 6B illustrates an example of a method of changing a shape of a button for a scan, according to an embodiment.

FIG. 6C illustrates an example of a method of adjusting a degree to which a direction indicated by an indicator is changed, according to an embodiment.

FIGS. 7A and 7B illustrate an example of a method of performing a three-dimensional scan based on inputs to buttons for a scan, according to an embodiment.

FIG. 8 illustrates an example of an operation flow for a method of performing a three-dimensional scan, based on inputs to buttons for a scan, according to an embodiment.

### DESCRIPTION OF EMBODIMENTS

The electronic device (or the external electronic device) according to various embodiments may be one of various types of electronic devices. The electronic devices may include, for example, a portable communication device (e.g., a smartphone), a computer device, a portable multimedia device, a portable medical device, a camera, a wearable device, a server, or a home appliance. According to an embodiment of the disclosure, the electronic devices (or the external electronic device) are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with the present document, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium that is readable by a machine (e.g., the electronic device 101). For example, a processor of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™ or AppStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, an electronic device may display a screen including at least a portion of a virtual space. The screen may include a player character (PC) corresponding to a user of the electronic device and one or more objects. The user may identify (or scan) a target object to be a target of interaction from among the one or more objects in the virtual space. A method for identifying not only an object located on a plane in the virtual space but also an object located above a specified altitude may be needed.

The technical problems to be achieved in this document are not limited to those described above, and other technical problems not mentioned herein will be clearly understood by those having ordinary knowledge in the art to which the present disclosure belongs, from the following description.

An electronic device may comprise a display. The electronic device may comprise a processor. The processor may be configured to display, via the display, a screen including a virtual space including a player character (PC) corresponding to a user of the electronic device and one or more objects. The screen may include a sphere-shaped button for a scan of a target object from among the one or more objects. The processor may be configured to display, in response to identifying initiation of a pan input on the button, a user interface (UI) for guiding the scan. The UI may include a sphere-shaped visual object surrounding the PC and an indicator indicating a first direction extending from a reference location corresponding to the PC in the virtual space. The processor may be configured to display, in a state of displaying the UI, based on movement of the pan input, the indicator indicating a second direction changed from the first direction. The processor may be configured to display, in response to identifying release of the pan input, the visually highlighted target object within a specified range from a scan location in the virtual space identified based on the second direction.

A method executed by an electronic device may comprise displaying, via a display of the electronic device, a screen including a virtual space including a player character (PC) corresponding to a user of the electronic device and one or more objects. The screen may include a sphere-shaped button for a scan of a target object from among the one or more objects. The method may comprise displaying, in response to identifying initiation of a pan input on the button, a user interface (UI) for guiding the scan. The UI may include a sphere-shaped visual object surrounding the PC and an indicator indicating a first direction extending from a reference location corresponding to the PC in the virtual space. The method may comprise displaying, in a state of displaying the UI, based on movement of the pan input, the indicator indicating a second direction changed from the first direction. The method may comprise displaying, in response to identifying release of the pan input, the visually highlighted target object within a specified range from a scan location in the virtual space identified based on the second direction.

In a computer-readable storage medium storing one or more programs, the one or more programs may be configured to comprise instructions which, when executed by a processor of an electronic device, cause the electronic device to display, via a display of the electronic device, a screen including a virtual space including a player character (PC) corresponding to a user of the electronic device and one or more objects. The screen may include a sphere-shaped button for a scan of a target object from among the one or more objects. The one or more programs may be configured to comprise instructions which, when executed by the processor of the electronic device, cause the electronic device to display, in response to identifying initiation of a pan input on the button, a user interface (UI) for guiding the scan. The UI may include a sphere-shaped visual object surrounding the PC and an indicator indicating a first direction extending from a reference location corresponding to the PC in the virtual space. The one or more programs may be configured to comprise instructions which, when executed by the processor of the electronic device, cause the electronic device to display, in a state of displaying the UI, based on movement of the pan input, the indicator indicating a second direction changed from the first direction. The one or more programs may be configured to comprise instructions which, when executed by the processor of the electronic device, cause the electronic device to display, in response to identifying release of the pan input, the visually highlighted target object within the specified range from a scan location in the virtual space identified based on the second direction.

An electronic device may comprise a display. The electronic device may comprise a processor. The processor may be configured to display, via the display, a player character (PC) corresponding to a user of the electronic device and virtual space including one or more objects. The screen may include a first button for a scan of a target object from among the one or more objects. The processor may be configured to display, based on a drag input on the first button, a first visual object representing a first location on a plane including a reference location corresponding to the PC in the virtual space. The processor may be configured to display, in a state where the first visual object is displayed, in response to release of the drag input, based on a press input on a second button changed from the first button, a second visual object representing a second location above an axis which extends from the first location and is perpendicular to the plane. The processor may be configured to display, in response to release of the press input, the visually highlighted target object within a specified range from the second location.

According to an embodiment, an electronic device can display a screen including at least a portion of a virtual space. The screen can include a player character (PC) corresponding to a user of the electronic device and one or more objects. The user can identify a target object to be a target of interaction from among the one or more objects in the virtual space. The electronic device can identify not only an object located on a plane in the virtual space but also an object located above a specified altitude by using a user interface for a three-dimensional scan.

The effects that can be obtained from the present disclosure are not limited to those described above, and any other effects not mentioned herein will be clearly understood by those having ordinary knowledge in the art to which the present disclosure belongs, from the following description.

Hereinafter, various embodiments of the present document will be described with reference to the accompanying drawings.

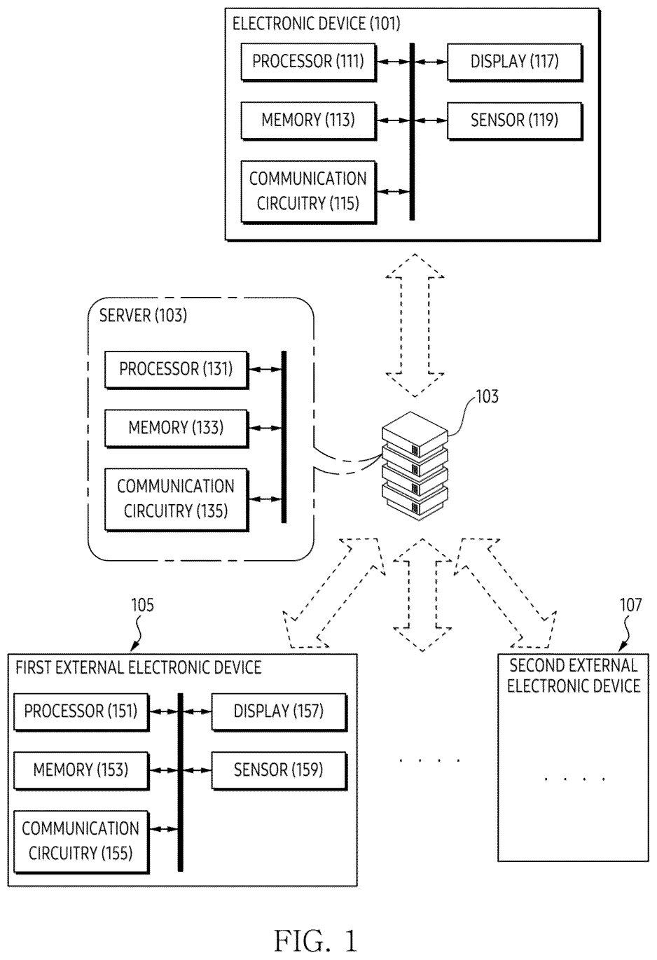

FIG. 1 is an exemplary block diagram of an electronic device in a network environment, according to an embodiment.

Referring to FIG. 1, an environment illustrated in FIG. 1 may include an electronic device 101, a plurality of external electronic devices 105 and 107, and a server 103. The electronic device 101 may be connected to the plurality of external electronic devices 105 and 107 based on a wired network and/or a wireless network. For example, the wired network may include a network such as the Internet, a local area network (LAN), a wide area network (WAN), Ethernet, or a combination thereof. The wireless network may include a network such as long-term evolution (LTE), 5G new radio (NR), wireless fidelity (WiFi), ZigBee, short-range wireless communication (NFC), Bluetooth, Bluetooth low energy (BLE), or a combination thereof. In FIG. 1, the electronic device 101 has been illustrated to be directly connected to the plurality of external electronic devices 105 and 107 through the server 103, but is not limited thereto. For example, the electronic device 101 and the plurality of external electronic devices 105 and 107 may be indirectly connected through one or more routers and/or one or more access points (APs).

The server 103 according to an embodiment may mean a server of a service provider. For example, the server 103 may register users of the electronic device 101 and the plurality of external electronic devices 105 and 107, which are client devices, based on linkage with a database that stores user information subscribed to a service (e.g., a multimedia content service or a game service), or may perform user authentication based at least on a relationship between account information received from at least one of the electronic device 101 and the plurality of external electronic devices 105 and 107, and account information stored in the database that stores the user information. For example, the service may include a game service provided to users who subscribe to the service. For example, the service may include a program, an application, and/or a library for providing the game service. For example, the server 103 may provide information on a virtual space related to the game service to the electronic device 101 and the plurality of external electronic devices 105 and 107. The virtual space may represent a virtual environment (or a game environment) implemented in the game service.

According to an embodiment, the electronic device 101 may process, based on linkage with a database (e.g., memory 133 of the server 103) that stores data for execution of a software application (e.g., a game software application) related to the service, an operation request related to the software application received from the plurality of external electronic devices 105 and 107, which are the client devices. The operation request related to the application received from the plurality of external electronic devices 105 and 107 may include avatar information corresponding to each account information of the users.

Referring to FIG. 1, the electronic device 101 according to an embodiment may include a personal computer such as a laptop and a desktop, a smartphone, a smart pad, a tablet, and smart accessories such as a smart watch and a head-mounted device (HMD). For example, the electronic device 101 may include at least one of a processor 111, memory 113, communication circuitry 115, a display 117, or a sensor 119. The processor 111, the memory 113, the communication circuitry 115, the display 117, and/or the sensor 119 may be electronically and/or operably coupled with each other by an electronic component such as a communication bus. A type and/or the number of hardware components included in the electronic device 101 is not limited as illustrated in FIG. 1. For example, the electronic device 101 may include only some of the hardware components illustrated in FIG. 1.

The processor 111 of the electronic device 101 according to an embodiment may include a hardware component for processing data based on one or more instructions. The hardware component for processing data may include, for example, an arithmetic and logic unit (ALU), a field programmable gate array (FPGA), and/or a central processing unit (CPU). The number of processors 111 may be one or more. For example, the processor 111 may have a structure of a multi-core processor such as a dual core, a quad core, or a hexa core.

The memory 113 of the electronic device 101 according to an embodiment may include a hardware component for storing data and/or instructions inputted to and/or outputted from the processor 111. The memory 113 may include, for example, volatile memory such as random-access memory (RAM) and/or non-volatile memory such as a read-only memory (ROM). The volatile memory may include, for example, at least one of dynamic RAM (DRAM), static RAM (SRAM), Cache RAM, and pseudo SRAM (PSRAM). The non-volatile memory may include, for example, at least one of a programmable ROM (PROM), erasable PROM (EPROM), electrically erasable PROM (EEPROM), flash memory, a hard disk, a compact disk, and an embedded multimedia card (eMMC).

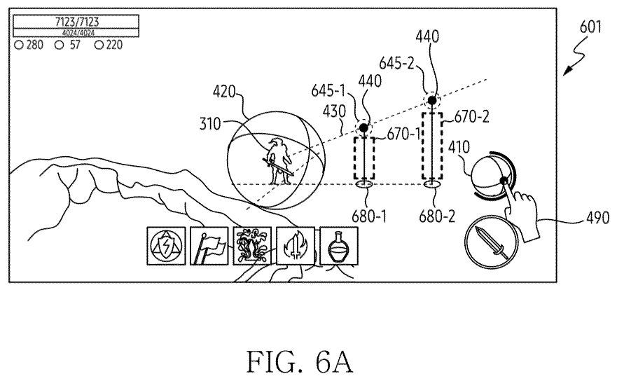

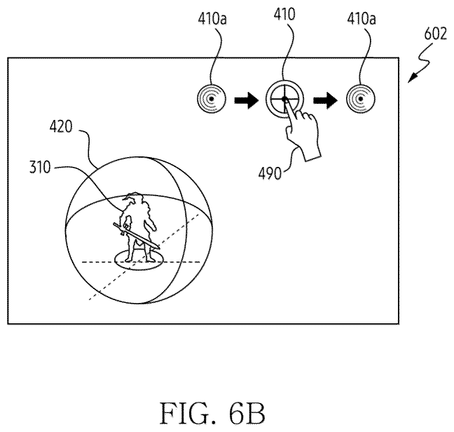

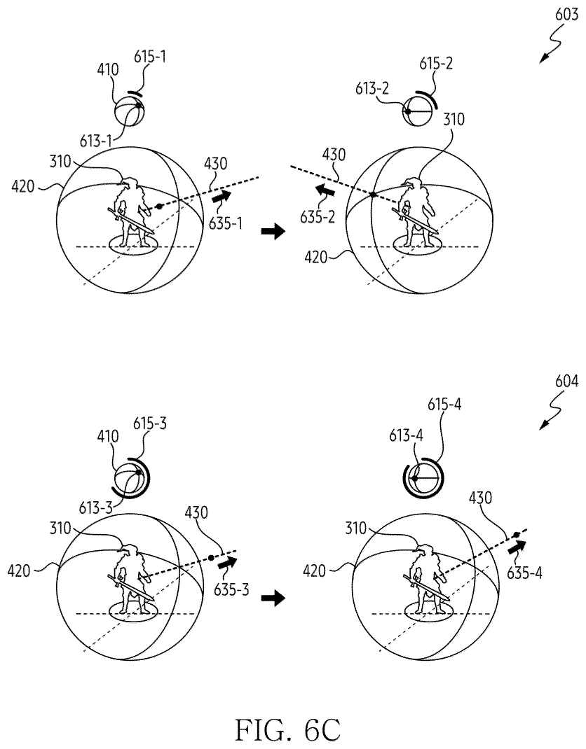

In the memory 113 of the electronic device 101 according to an embodiment, one or more instructions (or commands) indicating a calculation and/or an operation to be performed by the processor 111 of the electronic device 101 on data may be stored. A set of the one or more instructions may be referred to as firmware, an operating system, a process, a routine, a sub-routine and/or an application. For example, the electronic device 101 and/or the processor 111 may perform at least one of operations of FIG. 6 when a set of a plurality of instructions distributed in a form of an operating system, firmware, a driver, and/or an application is executed. In the following, an application being installed in the electronic device 101 may mean that one or more instructions provided in a form of the application are stored in the memory 113, and one or more applications are stored in an executable format (e.g., a file with an extension specified by an operating system of the electronic device 101). As an example, the application may include a program and/or a library related to a service provided to a user.

The communication circuitry 115 of the electronic device 101 according to an embodiment may include a hardware component for supporting transmission and/or reception of signals between the electronic device 101 and the plurality of external electronic devices 105 and 107. The communication circuitry 115 may include, for example, at least one of MODEM, an antenna, and an optic/electronic (O/E) converter. For example, the communication circuitry 115 may support transmission and/or reception of signals based on various types of protocols such as Ethernet, a local area network (LAN), a wide area network (WAN), wireless fidelity (WiFi), Bluetooth, Bluetooth low energy (BLE), ZigBee, long term evolution (LTE), and 5G new radio (NR).

The display 117 of the electronic device 101 according to an embodiment may output visualized information to the user by being controlled by a controller such as the processor 111. The display 117 may include a flat panel display (FPD) and/or electronic paper. The FPD may include a liquid crystal display (LCD), a plasma display panel (PDP), and/or one or more light emitting diodes (LEDs). The LED may include an organic LED (OLED). For example, the display 117 may be used to display an image obtained by the processor 111 or an image obtained by display driving circuitry. For example, the electronic device 101 may display an image on a portion of the display 117 according to control of the display driving circuitry. However, it is not limited thereto. For example, the electronic device 101 may display, based on receiving information on multimedia content (e.g., a game screen) from the server 103, the multimedia content including an avatar corresponding to the electronic device 101 on the display 117.

The sensor 119 of the electronic device 101 according to an embodiment may identify an input for the display 117. For example, the sensor 119 may identify the input on the display 117 by the user of the electronic device 101. For example, the input may include at least one of a touch input including a contact point with respect to at least a portion on the display 117, a drag input to the display 117, or a hovering input to the display 117. For example, the sensor 119 may detect an operating state (e.g., power or temperature) of the electronic device 101 according to the input or an external environmental state (e.g., user state), and generate an electrical signal or a data value corresponding to the detected state. For example, the sensor 119 may include a gesture sensor, a gyro sensor, a barometric pressure sensor, a magnetic sensor, an acceleration sensor, an inertial measurement unit (IMU) sensor, a grip sensor, a proximity sensor, a color sensor, an infrared (IR) sensor, a biometric sensor, a temperature sensor, a humidity sensor, or an illuminance sensor.

The server 103 according to an embodiment may include at least one of a processor 131, the memory 133, and communication circuitry 135. The processor 131, the memory 133, or the communication circuitry 135 may be electronically and/or operably coupled with each other by an electronic component such as a communication bus. A type and/or the number of hardware components included in the server 103 is not limited as illustrated in FIG. 1. For example, the server 103 may include only some of the hardware components illustrated in FIG. 1. For example, the processor 131 may correspond to the processor 111 of the electronic device 101. For example, the memory 133 may correspond to the memory 113 of the electronic device 101. The communication circuitry 135 may correspond to the communication circuitry 155 of the electronic device 101. To reduce repetition of a description, redundant descriptions may be omitted.

The server 103 according to an embodiment may store account information of users subscribed to a service (e.g., a game service) based on the server 103 in the memory 133. For example, the account information of the users may include player character (PC) information corresponding to the account information in the game service. In addition, for example, the account information of the users may include information on an electronic device owned by the users.

For example, the PC information may include stats, a level, and a skill of the PC and/or external appearance information of the PC. For example, the PC may include a playable character that performs a specified action based on an input of the user related to account information (or an electronic device) corresponding to the PC. For example, the PC may be different from a non-player character (NPC) that the user cannot operate. For example, the NPC may represent a character preset when designing the server 103 that provides a virtual space or the virtual space. For example, the NPC may perform interaction with the PC. For example, the NPC may include a monster. For example, the PC and the NPC may be included in an object (or a target object) that may be a target of the interaction.

For example, the server 103 may identify, based on receiving at least one signal from at least one electronic device owned by the user of the electronic device 101 and/or the plurality of external electronic devices 105 and 107, an input of the user. The electronic device 101 and/or the server 103 may control the PC based on identifying the input of the user.

According to an embodiment, the server 103 may include information for scanning (or identifying) the target object among one or more objects. For example, the information for scanning may include location information in the virtual space for the game service with respect to the one or more objects. For example, the location information may include coordinates (e.g., x coordinate, y coordinate, and z coordinate) for defining the virtual space. Alternatively, for example, the location information may include a coordinate (x, y, or z) on a vertical axis to a plane passing through a point on the plane of the virtual space. For example, the server 103 may provide the information for scanning to the electronic device 101 and/or the plurality of external electronic devices 105 and 107. However, the information included in the server 103 is not limited to the above-described example. As an example, it may further include information on a multimedia content service provided by the server 103, such as quest information of the multimedia content.

According to an embodiment, the plurality of external electronic devices 105 and 107 may be owned by different users. For example, the first external electronic device 105 and/or the second external electronic device 107 may include a personal computer such as a laptop and a desktop, a smartphone, a smart pad, a tablet personal computer (PC), and smart accessories such as a smart watch and a head-mounted device (HMD). For example, the plurality of external electronic devices 105 and 107 may be an example of an electronic device that receives a service (e.g., a game service) through the server 103. Each user using the first external electronic device 105 and/or the second external electronic device 107 may be subscribers of the service provided by the electronic device 101. Although only two external electronic devices 105 and 107 are illustrated in FIG. 1, an embodiment of the present disclosure is not limited thereto. For example, the server 103 may be connected to three or more external electronic devices.

The first external electronic device 105 of the plurality of external electronic devices 105 and 107 according to an embodiment may include at least one of a processor 151, memory 153, communication circuitry 155, a display 157, or a sensor 159. The processor 151, the memory 153, the communication circuitry 155, the display 157, and/or the sensor 159 may be electronically and/or operably coupled with each other by an electronic component such as a communication bus. A type and/or the number of hardware components included in the first external electronic device 105 is not limited as illustrated in FIG. 1. For example, the first external electronic device 105 may include only some of the hardware components illustrated in FIG. 1. For example, the processor 151 may correspond to the processor 111 of the electronic device 101. For example, the memory 153 may correspond to the memory 113 of the electronic device 101. The communication circuitry 155 may correspond to the communication circuitry 115 of the electronic device 101. The display 157 may correspond to the display 117 of the electronic device 101. The sensor 159 may correspond to the sensor 119 of the electronic device 101. To reduce repetition of a description, redundant descriptions may be omitted.

According to an embodiment, each (e.g., the second external electronic device 107) of the plurality of external electronic devices 105 and 107 may include at least some or all of the components included in the first external electronic device 105. Each of the plurality of external electronic devices including the second external electronic device 107 may be independently configured by including the at least some or all of the components included in the first external electronic device 105.

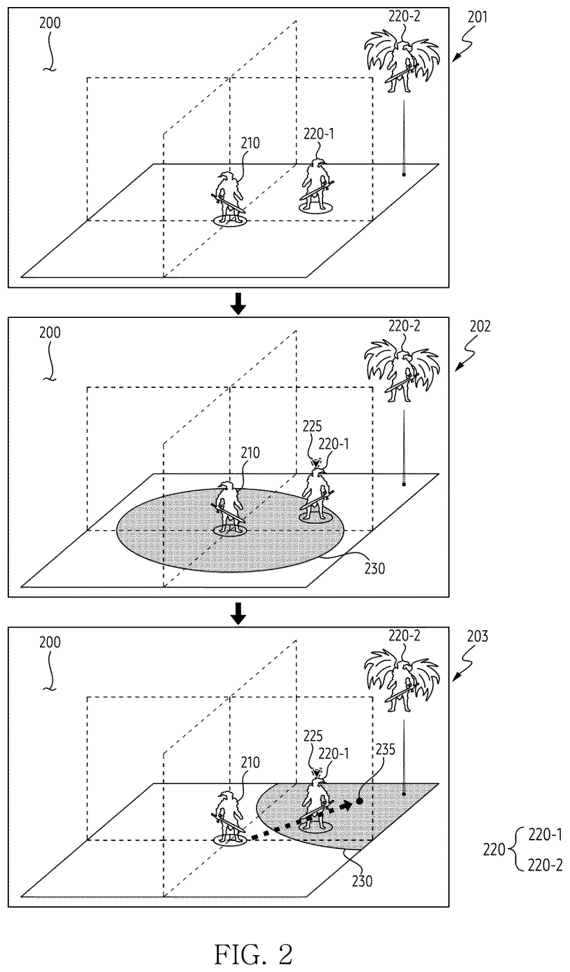

As described above, the electronic device 101 according to an embodiment may display a screen including at least a portion of the virtual space through the display 117. For example, the screen may include PC corresponding to the user of the electronic device 101. According to an embodiment, the screen may include the PC and one or more objects. For example, the one or more objects may include PC of the virtual space or NPC of the virtual space corresponding to another user. The user may identify a target object from among the one or more objects to perform interaction using the PC. For example, the target object may represent an object to be a target of the interaction. Identifying the target object may be referred to as performing scan (or scanning) the target object. Based on the scan, the target object may be targeted. Hereinafter, in FIG. 2, an example in which the electronic device 101 scans an object located on a plane of the virtual space formed in three dimensions will be described.

FIG. 2 illustrates an example of a method of scanning an object located on a plane of a virtual space, according to an embodiment. The virtual space may represent a virtual environment (or a game environment) implemented in the game service. For example, the virtual space may be formed in three dimensions.

FIG. 2 illustrates an example of screens 201, 202 and 203 scanned by PC 210 corresponding to a user of an electronic device 101 in the virtual space. For example, the screens 201, 202 and 203 may be displayed through a display (e.g., the display 117 of FIG. 1) of the electronic device 101.

For example, the screens 201, 202 and 203 may include the PC 210 corresponding to the user, a plurality of objects 220, and a virtual space 200. For example, it is exemplified that each of the screens 201, 202 and 203 of FIG. 2 includes the PC 210, a first object 220-1, and a second object 220-2, but an embodiment of the present disclosure is not limited thereto. For example, the screens 201, 202 and 203 may include three or more objects or one object. For example, the virtual space 200 may represent at least a portion of the virtual environment provided through the game service. For example, the virtual space 200 may represent a region of the virtual environment that may be displayed through the screens 201, 202 and 203.

For example, referring to the screen 201, the PC 210 and the first object 220-1 may be located on a plane. For example, the plane may represent a plane including a reference position corresponding to the PC 210. For example, the reference location may represent a location of the PC 210 in the virtual space 200. The PC 210 and the first object 220-1 being located on the plane may represent that an altitude of the PC 210 and an altitude of the first object 220-1 correspond to each other. The altitude may represent a height in the virtual space 200. For example, the altitude may be defined by a z-coordinate among coordinates (e.g., x-coordinate, y-coordinate, and z-coordinate) to define the virtual space 200.

For example, referring to the screen 202, the electronic device 101 may perform a scan for a specified range 230 around the reference location of the PC 210. Based on the scan, the electronic device 101 may identify the first object 220-1 as a target object among the first object 220-1 and the second object 220-2. For example, the electronic device 101 may display an indicator 225 for displaying the visually highlighted target object. It may be displayed above the first object 220-1, which is the target object. The scan performed around the reference location may be referred to as a short-range scan.

For example, referring to the screen 203, the electronic device 101 may perform a scan for the specified range 230 around a location 235 different from the reference location of the PC 210. Based on the scan, the electronic device 101 may identify the first object 220-1 as a target object among the first object 220-1 and the second object 220-2. For example, the electronic device 101 may display the indicator 225 for representing the target object. The scan performed around the location 235 different from the reference location may be referred to as a long-distance scan.

Referring to FIG. 2, the specified range 230 may be a virtual region defined only in the plane (e.g., the x coordinate and the y coordinate) of the virtual space 200. Therefore, even if the scan is performed based on the specified range 230, the second object 220-2 spaced apart from the plane by a altitude (e.g., a z-coordinate) may not be identified.

Accordingly, a method for scanning (or identifying) an object located at the altitude of the virtual space 200 may be needed. Hereinafter, an electronic device, a method, and a computer-readable storage medium are proposed to perform scanning (hereinafter referred to as a three-dimensional scan) on the object located at the altitude as well as an object located on a plane. The electronic device, the method, and the computer-readable storage medium according to an embodiment of the present disclosure may quickly and accurately identify a target object by performing the three-dimensional scan through a convenient UI. The UI may be designed so that users using the game service may perform the three-dimensional scan with only one hand operation. Accordingly, the users using the game service may increase their immersion in the game service by receiving an intuitive experience for the three-dimensional space.

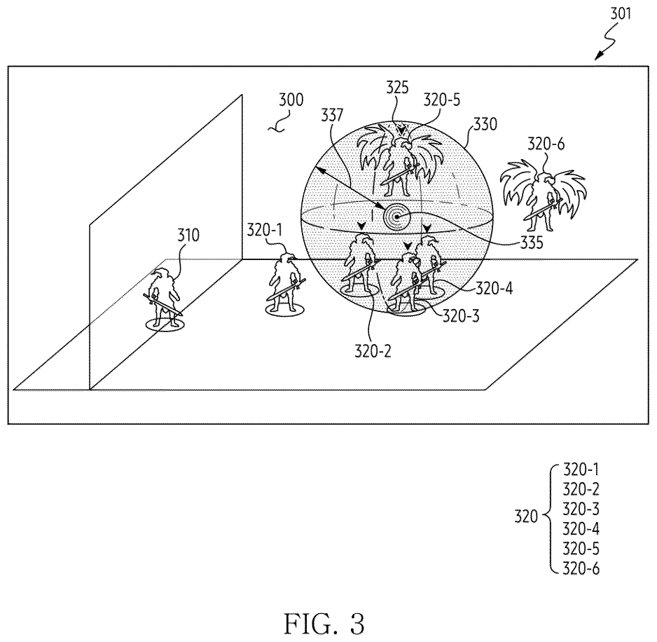

FIG. 3 illustrates an example of a method of scanning an object located on a plane of a virtual space and an object located above the plane, according to an embodiment.

FIG. 3 illustrates an example of a screen 301 scanned by PC 310 corresponding to a user of an electronic device 101 in a virtual space. For example, the screen 301 may be displayed through a display (e.g., the display 117 of FIG. 1) of the electronic device 101.

For example, the screen 301 may include the PC 310 corresponding to the user, a plurality of objects 320, and a virtual space 300. For example, the plurality of objects 320 may include a first object 320-1, a second object 320-2, a third object 320-3, a fourth object 320-4, a fifth object 320-5, and a sixth object 320-6. The screen 301 illustrated in FIG. 3 is merely an example for convenience of explanation, and an embodiment of the present disclosure is not limited thereto. For example, the screen 301 may include seven or more objects or five or less objects. Alternatively, the screen 301 may include one object. Alternatively, the screen 301 may not include an object. For example, the virtual space 300 may represent at least a portion of a virtual environment provided through the game service.

For example, referring to the screen 301, the PC 310, the first object 320-1, the second object 320-2, the third object 320-3, and the fourth object 320-4 may be located on a plane. For example, the plane may represent a plane including a reference position corresponding to the PC 310. For example, the reference location may represent a location of the PC 310 in the virtual space 300. The PC 310 and the first object 320-1 being located on the plane may represent that an altitude of the PC 310 and an altitude of the first object 320-1 correspond to each other. The altitude may represent a height in the virtual space 300. For example, the altitude may be defined by a z-coordinate among coordinates (e.g., x-coordinate, y-coordinate, and z-coordinate) to define the virtual space 300.

According to an embodiment, the electronic device 101 may perform a scan on a region 330 within a specified range 337 around a location 335 different from the reference location of the PC 310. Unlike FIG. 2, the location 335 may represent a point having a altitude value (e.g., z-coordinate) in the virtual space 300. According to an embodiment, the specified range 337 may be identified based on a value set in the game service providing the virtual space 300, set by the user of the electronic device 101, or set according to stats (or skill) of the PC 310.

According to an embodiment, the electronic device 101 may identify the second object 320-2, the third object 320-3, the fourth object 320-4, and the fifth object 320-5 among the plurality of objects 320 based on the scan on the region 330. For example, the electronic device 101 may identify the second object 320-2, the third object 320-3, the fourth object 320-4, and the fifth object 320-5 as a target object. According to an embodiment, the electronic device 101 may display an indicator 325 for displaying the visually highlighted target object. For example, the electronic device 101 may display the indicator 325 for each of the second object 320-2, the third object 320-3, the fourth object 320-4, and the fifth object 320-5. According to an embodiment, the indicator 325 may be displayed above the second object 320-2, the third object 320-3, the fourth object 320-4, and the fifth object 320-5, that are the target object. In FIG. 3, an example of visually highlighting and displaying through the indicator 325 formed of a ‘v’-shaped visual object is described, but the embodiment of the present disclosure is not limited thereto.

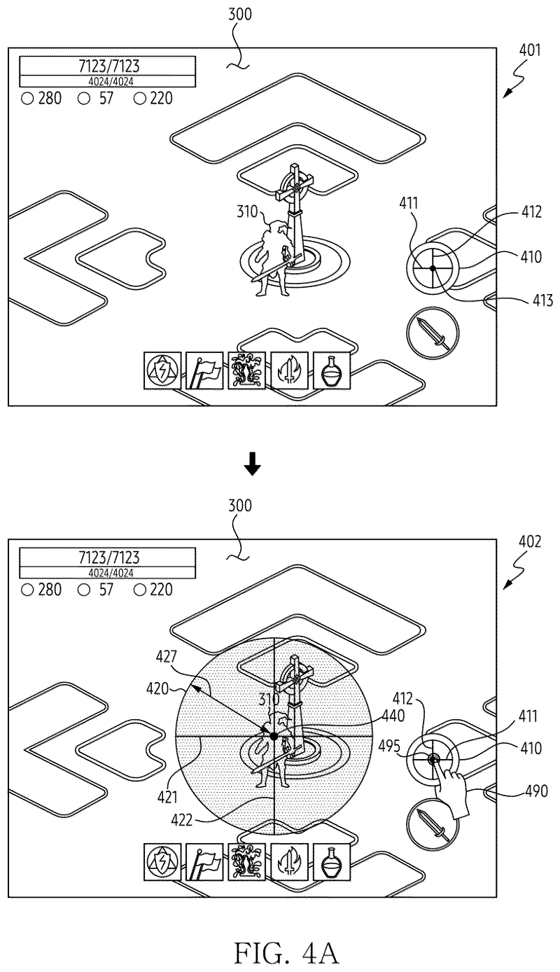

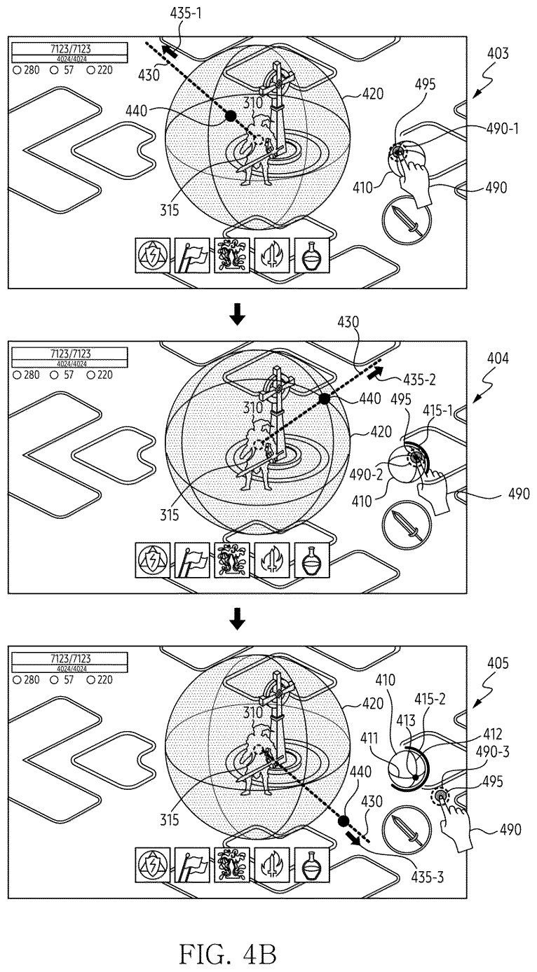

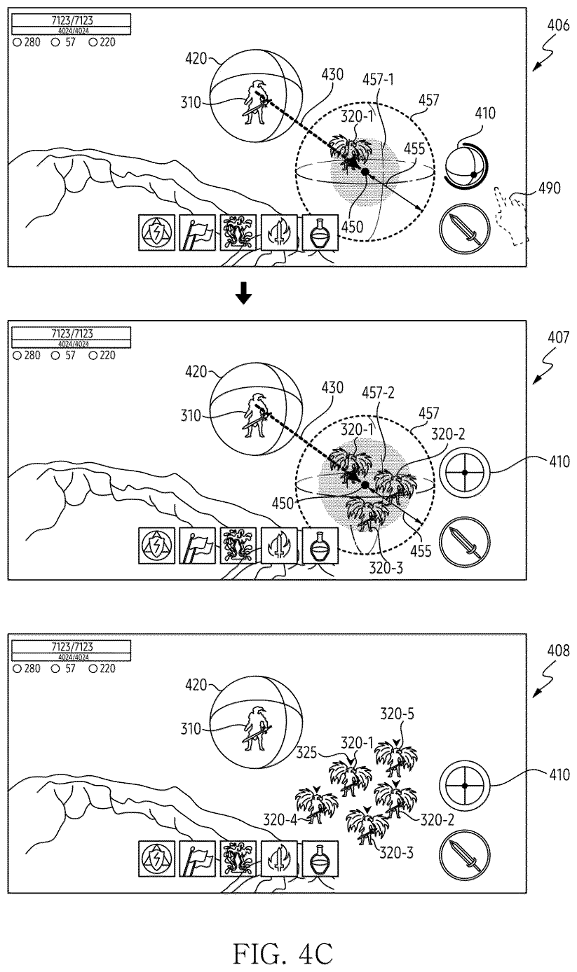

Referring to FIG. 3, unlike FIG. 2, the region 330 may be a virtual region defined for a space (e.g., x-coordinate, y-coordinate, and z-coordinate) of the virtual space 300. Accordingly, the electronic device 101 may identify the fifth object 320-5 spaced apart by a altitude (e.g., a z-coordinate) as the target object. Hereinafter, in FIGS. 4A to 8, methods for more conveniently and intuitively identifying (or specifying) the region 330 defined for the space of the virtual space 300 are described.

FIGS. 4A to 4C illustrate an example of a method of performing a three-dimensional scan based on an input to a button for a scan, according to an embodiment.

The scan may represent an operation of identifying a target object from among one or more objects. For example, the three-dimensional scan may be referred to as the scan performed by considering not only a plane of the virtual space defined by some coordinates (e.g., x coordinate and y coordinate) but also an altitude of the virtual space defined by another coordinate (e.g., z coordinate).

The method of FIGS. 4A to 4C may be performed by the electronic device 101 of FIG. 1. For example, at least a portion of the method may be controlled by a processor 111 of the electronic device 101.

Referring to FIG. 4A, the electronic device 101 may display a screen 401. For example, the electronic device 101 may display the screen 401 through a display (e.g., the display 117 of FIG. 1).

According to an embodiment, the screen 401 may include a virtual space 300, PC 310 corresponding to a user of the electronic device 101, and a button 410 for the scan. For example, the virtual space 300 may represent at least a portion of a virtual environment provided through the game service. On the screen 401, an object different from the PC 310 is not illustrated, but this is only for convenience of explanation and an embodiment of the present disclosure is not limited thereto. For example, the screen 401 may include one or more objects.

According to an embodiment, the button 410 may represent a visual object for the scan. For example, the button 410 may be formed in a sphere shape. According to an embodiment, the electronic device 101 may perform the scan based on obtaining an input to the button 410. For example, the input may include a pan input. For example, the pan input may represent an input of moving in a state of maintaining at least a portion of a contact point with respect to a display region of the display, after contacting a portion (e.g., a portion corresponding to the button 410) of the display region of the display of the electronic device 101 through an input device (e.g., a body part (e.g., finger) of the user)).

According to an embodiment, the button 410 may include a first guide line 411, a second guide line 412, and a guide point 413. For example, the first guide line 411, the second guide line 412, and the guide point 413 may represent visual objects included in the button 410. For example, the first guide line 411 may be formed along a first direction. For example, the second guide line 412 may be formed along a second direction different from the first direction. For example, in a state of the button 410 (e.g., a state in which there is no input to the button 410), the second direction may be perpendicular to the first direction. For example, the guide point 413 may represent an intersection of the first guide line 411 and the second guide line 412. Shapes or locations of the first guide line 411, the second guide line 412, and the guide point 413 may be changed based on a location of the input to the button 410. An embodiment related to this is described in FIG. 4B below.

In an example of a screen 402, according to an embodiment, the electronic device 101 may display a user interface (UI) for guiding the scan in response to identifying initiation of an input 490 to the button 410. For example, the electronic device 101 may display the screen 402 changed from the screen 401 based on identifying the initiation of the input 490. In FIG. 4A, it is exemplified that separate screens 401 and 402 are displayed, but this is only illustrated by dividing them into the separate screens 401 and 402 for convenience of explanation, and the screen 402 may be continuously displayed for the screen 401.

According to an embodiment, the electronic device 101 may display a visual object 495 for representing a location of the input 490, based on obtaining the input 490. For example, the electronic device 101 may display the screen 402 including the visual object 495 representing the location of the input 490 performed by the user.

For example, referring to the screen 402, the electronic device 101 may display a visual object 420, an indicator (not illustrated), and an icon 440 in response to identifying the initiation of the input 490 to the button 410. However, the embodiment of the present disclosure is not limited thereto. For example, the electronic device 101 may display the UI excluding the visual object 420 or the icon 440.

According to an embodiment, the visual object 420 may represent a sphere-shaped visual object surrounding the PC 310. For example, the visual object 420 may represent a visual object for more intuitively providing a location of the three-dimensional scan (hereinafter referred to as a scan location). For example, the visual object 420 may be formed in a spherical shape based on a length 427 specified from a reference location. For example, the reference location may represent a location of the PC 310 in the virtual space 300.

According to an embodiment, the visual object 420 may include a third guide line 421 and a fourth guide line 422. For example, the third guide line 421 and the fourth guide line 422 may represent visual objects included in the visual object 420. For example, the third guide line 421 may be formed along the first direction. For example, the fourth guide line 422 may be formed along the second direction. For example, in a state of the visual object 420 (e.g., the input 490 is located at the center of the button 410), the second direction may be perpendicular to the first direction. For example, shapes or locations of the third guide line 421 and the fourth guide line 422 may be changed based on a location of the input 490 to the button 410. An embodiment related to this is described in FIG. 4B below.

According to an embodiment, the indicator may represent a visual object indicating a direction extending from the reference location in the virtual space 300. The screen 402 represents a case in which the direction is a direction perpendicular to the screen 402 from the reference location, and the indicator may be displayed as if it is not included in the screen 402. For example, in the screen 402, the indicator may be in an overlapping state with the icon 440. According to an embodiment, an initial direction of the indicator may be changed in accordance with an initial position of the input 490 in the button 410. According to the input 490 corresponding to the center of the button 410 in an example of the screen 402, the initial direction of the indicator may be a direction perpendicular to the screen 402 from the reference location.

According to an embodiment, the icon 440 may represent a visual object for indicating the scan location. For example, an initial location of the icon 440 may correspond to the reference location.

According to an embodiment, the electronic device 101 may identify movement of the input 490 in a state of displaying the UI. For example, the movement may start from a portion of a display region of the display corresponding to the button 410 and represent that a location of the input 490 is changed while maintaining a contact point. For an example of screens displayed according to the movement, FIG. 4B may be referred to.

When referring to a screen 403 of FIG. 4B, according to an embodiment, the electronic device 101 may display the screen 403 changed from the screen 402 based on identifying the movement of the input 490 to the button 410. For example, the electronic device 101 may display the screen 403 changed from the screen 402 based on identifying that a location of the input 490 is changed from the initial location to a location 490-1. In FIGS. 4A and 4B, it is exemplified that separate screens 402 and 403 are displayed, but this is only illustrated by dividing them into the separate screens 402 and 403 for convenience of explanation, and the screen 403 may be continuously displayed for the screen 402.

Referring to the screen 403, according to an embodiment, the electronic device 101 may identify the input 490 of the location 490-1. According to an embodiment, the electronic device 101 may display the visual object 495 corresponding to the location 490-1.

According to an embodiment, the electronic device 101 may display an indicator 430 indicating a direction 435-1 changed from the initial direction based on the location 490-1 of the input 490. In an example of the screen 403, the electronic device 101 may identify the direction 435-1 based on the input 490 moved from the initial location (e.g., the center of the button 410) to the location 490-1 at an upper left of the button 410. For example, the electronic device 101 may display the indicator 430 facing the identified direction 435-1. According to an embodiment, the indicator 430 may represent a visual object represented by a dotted line extending from the reference location 315 and having a specified length. For example, the specified length may be identified based on a value set in the game service, set by the user of the electronic device 101, or set according to stats (or skill) of the PC 310.

According to an embodiment, a direction of the indicator 430 may be defined based on a coordinate (x, y, or z) above a vertical axis to a plane passing through a point on the plane (e.g., xy plane) in the virtual space 300 including the reference location 315. For example, the direction 435-1 of the indicator 430 may be defined based on the coordinate identified based on a location of the input 490 changed in accordance with the movement. The coordinate may be identified based on a relative location difference between the initial location of the input 490 and the location 490-1.

According to an embodiment, the electronic device 101 may display the icon 440 indicating a scan location changed from the reference location 315 based on the input 490. In an example of the screen 403, the electronic device 101 may display the icon 440 indicating the scan location changed from the reference location 315 based on a time interval (or input time interval) between a timing at which the input 490 is started and a timing at which the input 490 of the location 490-1 changed in accordance with the movement is identified.

When referring to a screen 404 of FIG. 4B, according to an embodiment, the electronic device 101 may display the screen 404 changed from the screen 403 based on identifying movement of the input 490 to the button 410. For example, the electronic device 101 may display the screen 404 changed from the screen 403 based on identifying the input 490 of a location 490-2 changed from the location 490-1 according to the movement. In FIG. 4B it is exemplified that separate screens 403 and 404 are displayed, but this is only illustrated by dividing into the separate screens 403 and 404 for convenience of explanation, and the screen 404 may be continuously displayed for the screen 403.

Referring to the screen 404, according to an embodiment, the electronic device 101 may identify the input 490 of the location 490-2. According to an embodiment, the electronic device 101 may display the visual object 495 corresponding to the location 490-2.

According to an embodiment, the electronic device 101 may display the indicator 430 indicating a direction 435-2 changed from the direction 435-1 based on the location 490-2 of the input 490. In an example of the screen 404, the electronic device 101 may identify the direction 435-2 based on the input 490 moved from the location 490-1 to the location 490-2 at an upper right of the button 410. For example, the electronic device 101 may display the indicator 430 facing the identified direction 435-2. For example, the direction 435-2 of the indicator 430 may be defined based on a coordinate of the virtual space 300 identified based on a location of the input 490 changed in accordance with the movement. The coordinate may be identified based on a relative location difference between the location 490-1 and the location 490-2 of the input 490.

According to an embodiment, the electronic device 101 may display the icon 440 indicating a scan location changed from a previous scan location based on the input 490. In an example of the screen 404, the electronic device 101 may display the icon 440 indicating the scan location changed from the previous scan location based on a time interval (or input time interval) between a timing at which the input 490 is started and a timing at which the input 490 of the location 490-2 changed in accordance with the movement is identified. The changed scan location indicated by the icon 440 of the screen 404 may be located farther from the reference location 315 than the previous scan location indicated by the icon 440 of the screen 403. For example, when the scan location indicated by the icon of the screen 403 is a first scan location and the scan location indicated by the icon 440 of the screen 404 is a second scan location, the second scan location may be located farther from the reference location 315 than the first scan location. This may be because an input time interval for the input 490 of the location 490-2 related to the second scan location is longer than an input time interval for the input 490 of the location 490-1 related to the first scan location.

According to an embodiment, the electronic device 101 may further display a progress bar 415-1 based on identifying that a specified time interval from a timing of identifying initiation of the input 490 to the button 410 has passed. For example, the electronic device 101 may display the progress bar 415-1 based on identifying a second timing after the specified time interval from the first timing of identifying the initiation of the input 490.

According to an embodiment, the progress bar 415-1 may represent a circular visual object which starts to be displayed from a point distant from a periphery of the button 410, and is displayed along the periphery. According to an embodiment, the progress bar 415-1 may have a length extending from the point. For example, the point may be located in an upper direction of the button 410. According to an embodiment, the length may be identified based on the input time interval of the input 490 having the location 490-2 to the button 410. According to an embodiment, the length may be identified based on a time difference between the input time interval and the specified time interval.

When referring to a screen 405 of FIG. 4B, according to an embodiment, the electronic device 101 may display the screen 405 changed from the screen 404 based on identifying movement of the input 490 to the button 410. For example, the electronic device 101 may display the screen 405 changed from the screen 404 based on identifying the input 490 of a location 490-3 moved from the location 490-2 in in accordance with the movement. In FIG. 4B, it is exemplified that separate screens 404 and 405 are displayed, but this is only illustrated by dividing them into the separate screens 404 and 405 for convenience of explanation, and the screen 405 may be continuously displayed for the screen 404.

Referring to the screen 405, according to an embodiment, the electronic device 101 may identify the input 490 of a location 490-3. According to an embodiment, the electronic device 101 may display the visual object 495 corresponding to the input 490 of the location 490-3.

According to an embodiment, the electronic device 101 may identify the input 490 even if it is out of the periphery of the button 410. For example, the electronic device 101 may identify the input 490 moved from the location 490-2, to the location 490-3 defined as the outside of the button 410 in a state of maintaining a contact point, as a continuous input to the button 410. Accordingly, the electronic device 101 may display the UI (e.g., the visual object 420, the indicator 430, and the icon 440) changed based on the location 490-3.

According to an embodiment, the electronic device 101 may display the indicator 430 indicating a direction 435-3 changed from the direction 435-2 based on the location 490-3 of the input 490. In an example of the screen 405, the electronic device 101 may identify the direction 435-3 based on the input 490 moved from the location 490-2 to the location 490-3 of a lower right outside the button 410. For example, the electronic device 101 may display the indicator 430 facing the identified direction 435-3. For example, the direction 435-3 of the indicator 430 may be defined based on a coordinate of the virtual space 300 identified based on a location of the input 490 in accordance with the movement. The coordinate may be identified based on a relative location difference between the location 490-2 and the location 490-3 of the input.

According to an embodiment, the electronic device 101 may display the icon 440 indicating a scan location changed from a previous scan location based on an input 490-3. In an example of the screen 405, the electronic device 101 may display the icon 440 indicating the scan location changed from the previous scan location based on a time interval (or input time interval) between a timing at which the input 490 is started and a timing at which the input 490-3 in accordance with the movement is identified. The scan location indicated by the icon 440 of the screen 405 may be located farther from the reference location 315 than the scan location indicated by the icon 440 of the screen 404. For example, when the scan location indicated by the icon of the screen 404 is the second scan location and the scan location indicated by the icon 440 of the screen 405 is a third scan location, the third scan location may be located farther from the reference location 315 than the second scan location. This may be because an input time interval for the input 490 of the location 490-3 related to the third scan location is longer than an input time interval for the input of the location 490-2 related to the second scan location.

According to an embodiment, a progress bar 415-2 may have a longer length compared to the progress bar 415-1. For example, the length of the progress bar 415-2 may represent a length moved along the periphery of the button 410 by about half. For example, the length may be identified based on the input time interval of the input 490 having the location 490-3 to the button 410.

Referring to FIG. 4B, as a location (e.g., the location 490-1, the location 490-2, or the location 490-3) of the input 490 to the button 410 is changed, a direction of the indicator 430 may be changed. In addition, a location (or scan location) of the icon 440 may be changed based on a length of the input time interval of the input 490 to the button 410 and the direction of the indicator 430. According to an embodiment, as the location of the input 490 to the button 410 is changed, shapes of the button 410 and the visual object 420 may also be changed. For example, at least one of locations or shapes of the first guide line 411, the second guide line 412, and the guide point 413 of the button 410 may be changed according to the location of the input 490 respect to the button 410. In addition, for example, at least one of locations or shapes of the third guide line 421 and the fourth guide line 422 of the visual object 420 may be changed according to the location of the input 490 to the button 410.

According to an embodiment, the electronic device 101 may identify release of the input 490 to the button 410 in a state of displaying the UI. For an example of screens displayed according to the release, FIG. 4C may be referred to.

When referring to a screen 406 of FIG. 4C, according to an embodiment, the electronic device 101 may display the screen 406 changed from the screen 405 based on identifying the release of the input 490 to the button 410. For example, the electronic device 101 may display the screen 406 changed from the screen 405 in response to identifying the release of the input 490. In FIGS. 4B and 4C, it is exemplified that separate screens 405 and 406 are displayed, but this is only illustrated by dividing them into separate screens 405 and 406 for convenience of explanation, and the screen 406 may be continuously displayed for the screen 405.

Referring to the screen 406, according to an embodiment, the electronic device 101 may identify the release of the input 490. According to an embodiment, the release may indicate that a body part of the user is distant from a display (e.g., the display 117 of FIG. 1). According to an embodiment, the release may be identified when an input time interval of the input exceeds a threshold time. For example, the threshold time may indicate a limit on the input time interval. According to an embodiment, when the input time interval corresponds to the threshold time, a shape of a progress bar displayed together with the button 410 may be circular.

According to an embodiment, the electronic device 101 may change a shape of the button 410 based on the release. Content related to this is described in FIG. 6B below.

According to an embodiment, the electronic device 101 may identify a scan location 450 based on the release. For example, the electronic device 101 may identify the scan location 450 on the indicator 430 in which the icon 440 indicates a direction at a timing of identifying the release of the input 490.

According to an embodiment, the electronic device 101 may display a visual effect based on the release. For example, the electronic device 101 may display the visual effect extending from the scan location 450 to a specified range 455. The visual effect may be used to identify a target object among one or more objects in the virtual space 300. For example, the visual effect may extend from the scan location 450 to the specified range 455. For example, the specified range 455 may be identified based on a value set in the game service providing the virtual space 300, set by the user of the electronic device 101, or set according to stats (or skill) of the PC 310.

According to an embodiment, the electronic device 101 may perform a scan for identifying the target object based on a region 457 in which the visual effect is displayed. For example, the visual effect may be displayed in the region 457 as it sequentially extends from the scan location 450 to the specified range 455. The electronic device 101 may identify an object in the region 457 of the visual effect that sequentially extends as the target object. For content related to this, the screen 406 to a screen 408 may be referred to.

Referring to the screen 406, the electronic device 101 may display the visual effect representing a first region 457-1 from the scan location 450. For example, the electronic device 101 may identify an object 320-1 in the first region 457-1. The electronic device 101 may identify an object 320-1 as a target object and display an indicator (not illustrated) (e.g., the indicator 325 of FIG. 3 or the indicator 325 of the screen 408) for indicating the target object. In addition, referring to the screen 407, the electronic device 101 may display the visual effect representing a second region 457-2 extending from the first region 457-1. For example, the electronic device 101 may identify the object 320-1, the object 320-2, and an object 320-3 in the second region 457-2. The electronic device 101 may identify the object 320-1, the object 320-2, and the object 320-3 as the target object, and may display an indicator (not illustrated) for the object 320-1, the object 320-2, and the object 320-3. In addition, referring to the screen 408, the electronic device 101 may identify the object 320-1, the object 320-2, the object 320-3, an object 320-4, and an object 320-5 in a region (not illustrated) defined based on the scan location 450 and the specified range 455. The electronic device 101 may identify the object 320-1, the object 320-2, the object 320-3, the object 320-4, and the object 320-5 as the target object. The electronic device 101 may display the indicator 325 for the object 320-1, the object 320-2, the object 320-3, the object 320-4, and the object 320-5.

Although not illustrated on the screen 408, according to an embodiment, the visual effect may extend to the region 457 of the screen 407 and then disappear. For example, the electronic device 101 may cease display of the visual effect, which starts extending from the scan location 450 and reaches the region 457. In addition, according to an embodiment, the electronic device 101 may cease display of the UI (e.g., the visual object 420, the indicator 430, and the icon 440) for the scan, together with ceasing the display of the visual effect. Referring to the above, the electronic device 101 may identify a target object based on the scan location 450 based on identifying the release of the input 490, and may cease the display of the UI for the scan and the display of the visual effect.

According to an embodiment, the electronic device 101 may perform the operations of FIGS. 4A to 4C again in response to identifying another input to the button 410 after ceasing the displaying.

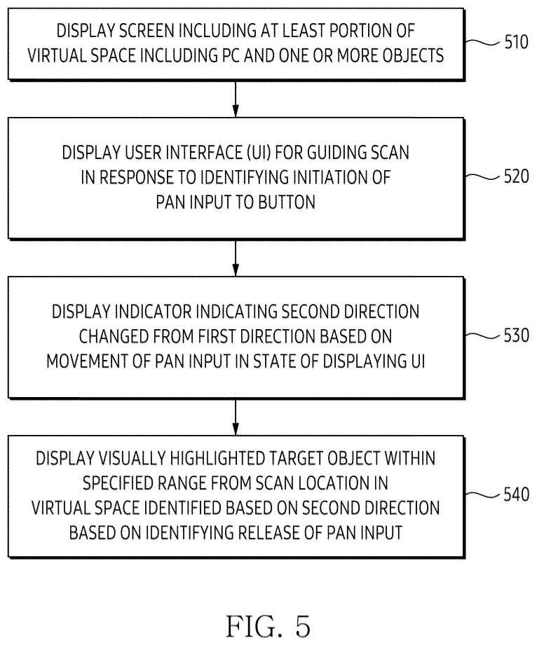

FIG. 5 illustrates an example of an operation flow for a method of performing a three-dimensional scan based on an input to a button for a scan, according to an embodiment.

An electronic device of FIG. 5 may include the electronic device 101 of FIG. 1. At least one of operations of FIG. 5 may be performed by the electronic device 101 of FIG. 1. For example, at least one of the operations may be controlled by the processor 111 of FIG. 1. Each of the operations of FIG. 5 may be performed sequentially, but is not necessarily performed sequentially. For example, an order of each of the operations may be changed, and at least two operations may be performed in parallel.

In operation 510, an electronic device 101 may display a screen including at least a portion of a virtual space including PC and one or more objects. For example, the electronic device 101 may display the screen through a display (e.g., display 117 of FIG. 1).

According to an embodiment, the screen may include the at least a portion of the virtual space, the PC corresponding to the user, the one or more objects, the virtual space, and a button. In the above example, it is described that the screen includes the one or more objects, but an embodiment of the present disclosure is not limited thereto. For example, the screen may not include an object. For example, the screen may include screens 401 to 408 of FIGS. 4A to 4C.

According to an embodiment, the button may represent a visual object for scanning a target object among the one or more objects. For example, the button may represent a sphere-shaped visual object.

According to an embodiment, the button may include a first guide line, a second guide line, and a guide point. For example, the first guide line, the second guide line, and the guide point may represent visual objects included in the button. For example, the first guide line may be formed along a first direction. For example, the second guide line may be formed along a second direction different from the first direction. For example, the second direction may be perpendicular to the first direction. For example, the guide point may represent an intersection of the first guide line and the second guide line. Shapes or locations of the first guide line, the second guide line, and the guide point may be changed based on a location of the input to the button.

In operation 520, the electronic device 101 may display a user interface (UI) for guiding the scan in response to identifying initiation of a pan input to the button.

According to an embodiment, the UI may include a sphere-shaped visual object surrounding the PC and an indicator indicating the first direction extending from a reference location corresponding to the PC in the virtual space. For example, the first direction is identified based on a location of the pan input within the button at a timing of identifying the initiation of the pan input. For example, the first direction may be referred to as an initial direction.

According to an embodiment, the sphere-shaped visual object may represent a visual object for more intuitively providing a location (hereinafter, a scan location) of the three-dimensional scan. For example, the sphere-shaped visual object may be formed in a spherical shape based on a length specified from the reference location. For example, the reference location may represent a location of the PC in the virtual space.

According to an embodiment, the sphere-shaped visual object may include a third guide line and a fourth guide line. For example, the third guide line and the fourth guide line may represent visual objects included in the sphere-shaped visual object. For example, the third guide line may be formed along the first direction. For example, the fourth guide line may be formed along the second direction. For example, the second direction may be perpendicular to the first direction. For example, shapes or locations of the third guide line and the fourth guide line may be changed based on the location of the input to the button.

According to an embodiment, the indicator may represent a visual object for indicating a direction (e.g., the first direction) extending from the reference location in the virtual space.

According to an embodiment, the electronic device 101 may display the UI further including an icon for indicating the scan location on the indicator in response to identifying the initiation of the pan input. For example, an initial location of the icon may correspond to the reference location.

In operation 530, the electronic device 101 may display the indicator indicating the second direction changed from the first direction based on movement of the pan input in a state of displaying the UI. For example, the second direction may be identified based on a location of the pan input changed according to the movement in the button.

According to an embodiment, a direction of the indicator including the first direction and the second direction may be defined based on a coordinate on a vertical axis to a plane passing through a point on the plane in the virtual space including the reference location. For example, the first location may be identified based on an x coordinate and a y coordinate defining the virtual space. The second location may be identified based on a z-coordinate defining the virtual space.

According to an embodiment, the electronic device 101 may display the icon having the scan location changed from the reference location based on an input time interval of the pan input in a state displaying the UI. The input time interval may be identified based on current time at which the pan input is maintained from a timing at which the pan input is started.

In operation 540, the electronic device 101 may display the visually highlighted target object within a specified range from the scan location in the virtual space identified based on the second direction based on identifying release of the pan input.

According to an embodiment, the electronic device 101 may identify the release for the pan input. According to an embodiment, the release may represent that a body part of the user is distant from a display (e.g., the display 117 of FIG. 1).

According to an embodiment, the electronic device 101 may identify the scan location based on the release. For example, the electronic device 101 may identify the scan location on the indicator at which the icon indicates a direction (e.g., the second direction) at a timing of identifying the release of the pan input.

According to an embodiment, the electronic device 101 may display a visual effect based on the release. For example, the electronic device 101 may display the visual effect in a region extending by the specified range from the scan location. The visual effect may be used to identify a target object among the one or more objects in the virtual space. For example, the visual effect may extend from the scan location to the specified range. For example, the specified range may be identified based on a value set in the game service providing the virtual space, set by the user of the electronic device 101, or set according to stats (or skill) of the PC. According to an embodiment, the electronic device 101 may display another indicator (e.g., the indicator 325 of FIG. 3) for indicating the target object above the target object.

According to an embodiment, the electronic device 101 may cease display of the visual effect, which starts extending from the scan location and reaches the region. In addition, according to an embodiment, the electronic device 101 may cease display of the UI (e.g., the sphere-shaped visual object 420, the indicator indicating the direction, and the icon indicating the scan location) for the scan, together with ceasing the display of the visual effect.

Referring to the above, the electronic device 101 may identify a target object based on the scan location based on identifying the release of the pan input, and may cease the display of the UI for the scan and the display of the visual effect.

FIG. 6A illustrates an example of a method of displaying a visual object for guiding a scan location, according to an embodiment.

The method of FIG. 6A may be performed by the electronic device 101 of FIG. 1. For example, a portion of the method may be controlled by the processor 111 of the electronic device 101.

FIG. 6A illustrates a screen 601 further including a visual object for guiding the scan location.

According to an embodiment, the screen 601 may include a UI for guiding the scan based on an input of the user to a button 410 of the electronic device 101. For example, the electronic device 101 may display the screen 601 including the UI on a display (e.g., the display 117 of FIG. 1) based on the input. The same reference number may be used for the same description.

According to an embodiment, the screen 601 may display an icon 440 having a scan location identified based on an input time interval of the input. For example, the input time interval may represent a time length from a timing at which the input starts to current time.

Referring to the screen 601, for example, when the input time interval is a first length, the icon 440 indicating a first scan location 645-1 may be displayed. In addition, for example, when the input time interval is a second length longer than the first length, the icon 440 indicating a second scan location 645-2 may be displayed.

According to an embodiment, the electronic device 101 may display a bar-shaped visual object for guiding the scan location. For example, the electronic device 101 may display the screen 601 further including a bar-shaped visual object 670-1 vertically extending from the first scan location 645-1 to a point on a plane in the virtual space including the reference location. For example, the reference location may represent a location of PC 310 in the virtual space. In addition, for example, the electronic device 101 may display the screen 601 further including a bar-shaped visual object 670-2 extending vertically from the second scan location 645-2 to another point on the plane including the reference location.

According to an embodiment, the electronic device 101 may display a circular visual object for guiding the scan location. For example, the electronic device 101 may display the screen 601 further including a circular visual object 680-1 including a point where the first scan location 645-1 is orthogonally projected on the plane. In addition, for example, the electronic device 101 may display the screen 601 further including a circular visual object 680-2 including another point where the second scan location 645-2 is orthogonally projected on the plane.

Referring to the above, the bar-shaped visual object 670-1 or 670-2 and the circular visual object 680-1 or 680-2 may represent a visual object for guiding the scan location through a shadow representation for the scan location of the icon 440 or a pillar. For convenience of explanation, in FIG. 6A, it is exemplified that the screen 601 includes both the bar-shaped visual object 670-1 or 670-2 and the circular visual object 680-1 or 680-2, but an embodiment of the present disclosure is not limited thereto. For example, the screen 601 may include at least one of the bar-shaped visual object 670-1 or 670-2 or the circular visual object 680-1 or 680-2. Alternatively, for example, the screen 601 may not include the bar-shaped visual object 670-1 or 670-2 and the circular visual object 680-1 or 680-2.

FIG. 6B illustrates an example of a method of changing a shape of a button for a scan, according to an embodiment.

The method of FIG. 6B may be performed by the electronic device 101 of FIG. 1. For example, at least a portion of the method may be controlled by the processor 111 of the electronic device 101.

FIG. 6B illustrates an example of a screen 602 for changing and displaying the shape of the button based on whether an input to the sphere-shaped button for the scan is identified. For example, the input may include a pan input.

Referring to the example 602, according to an embodiment, the electronic device 101 may display a screen including a button 410a of a first shape before identifying the input. In addition, according to an embodiment, the electronic device 101 may display a screen including a button 410 of a second shape changed from the first shape in response to identifying the input. For example, the second shape may have a size larger than a size of the first shape. A user of the electronic device 101 may adjust a more detailed scan location by displaying the second shape having a size larger than the first shape. In addition, according to an embodiment, the electronic device 101 may display the button 410a of the first shape again based on identifying release of the input.

FIG. 6C illustrates an example of a method of adjusting a degree to which a direction indicated by an indicator is changed, according to an embodiment.

The method of FIG. 6C may be performed by the electronic device 101 of FIG. 1. For example, at least a portion of the method may be controlled by the processor 111 of the electronic device 101.

FIG. 6C illustrates examples 603 and 604 of a method of adjusting a degree to which a direction indicated by an indicator 430 is changed.

Referring to the examples 603 and 604, the electronic device 101 may display a progress bar based on identifying that a specified time interval has passed from a timing of identifying initiation of the input to the sphere-shaped button 410 for the scan. For example, the electronic device 101 may start displaying the progress bar based on identifying a second timing after the specified time interval has passed from the first timing identifying the initiation of the input. According to an embodiment, the progress bar may represent a circular visual object, which starts to be displayed from a point distant from a periphery of the button 410, and is displayed along the periphery. According to an embodiment, the progress bar may have a length extending from the point. For example, the length may be identified based on an input time interval (or a time difference between the input time interval and the specified time interval) for the button 410.

Referring to the example 603, the electronic device 101 may display an indicator 430 indicating a first direction 635-1 based on the input of a first location to the button 410. The first location may indicate a location of the input at a third timing after a first time interval has elapsed from the first timing. The third timing may represent time after the second timing. For example, in response to the input of the first location, the electronic device 101 may display the button 410 including a guide point 613-1. For example, the button 410 including the guide point 613-1 may be changed in location and shape to correspond to the input of the first location.

In addition, referring to the example 603, the electronic device 101 may display the indicator 430 indicating a second direction 635-2 based on the input of a second location changed according to movement of the input to the button 410. The second location may represent a location of the input at a fourth timing after a second time interval has elapsed from the first timing. The fourth timing may represent time after the third timing. For example, in response to the input of the second location, the electronic device 101 may display the button 410 including a guide point 613-2. For example, the button 410 including the guide point 613-2 may be changed in location and shape to correspond to the input of the first location.

Referring to the example 604, the electronic device 101 may display the indicator 430 indicating a third direction 635-3 based on the input of a third location changed according to the movement of the input to the button 410. The third location may indicate a location of the input at a fifth timing after a third time interval has elapsed from the first timing. For example, the third location may correspond to the first location. The fifth timing may represent time after the third timing. For example, in response to the input of the third location, the electronic device 101 may display the button 410 including a guide point 613-3. For example, the button 410 including the guide point 613-3 may be changed in location and shape to correspond to the input of the third location.

In addition, referring to the example 604, the electronic device 101 may display the indicator 430 indicating a fourth direction 635-4 based on the input of a fourth location changed according to the movement of the input to the button 410. The fourth location may represent a location of the input at a sixth timing after a fourth time interval has elapsed from the first timing. For example, the fourth location may correspond to the second location. The sixth timing may represent time after the fifth timing. For example, in response to the input of the fourth location, the electronic device 101 may display the button 410 including a guide point 613-4. For example, the button 410 including the guide point 613-4 may be changed in location and shape to correspond to the input of the fourth location.

According to an embodiment, the electronic device 101 may adjust the degree to which the direction indicated by the indicator 430 is changed according to the timing at which the movement of the input to the button 410 is identified. For example, as the movement of the input to the button 410 is closer to the first timing (or a timing at which the input is started), an amount of change in the direction indicated by the indicator 430 according to the movement may be greater. Alternatively, as the movement of the input to the button 410 is farther from the first timing, an amount of change in the direction indicated by the indicator 430 according to the movement may be smaller.

Referring to the example 603, based on the movement changed from the first location to the second location, a direction of the indicator 430 may be changed from the first direction 635-1 to the second direction 635-2. According to an embodiment, the electronic device 101 may identify a first length representing the movement changed from the first location to the second location. In addition, referring to the example 604, a direction of the indicator 430 may be changed from the third direction 635-3 to the fourth direction 635-4, based on the movement changed from the third location to the fourth location. According to an embodiment, the electronic device 101 may identify a second length representing the movement changed from the third location to the fourth location. For example, the second length may correspond to the first length. In other words, the first length and the second length may be substantially the same. In this case, in the example 603 and the example 604, lengths representing the movement of the input correspond, but amounts of change in the direction indicated by the indicator 430 may be different each other. For example, a first value representing a difference between the first direction 635-1 and the second direction 635-2 in the example 603 may be greater than a second value representing a difference between the third direction 635-3 and the fourth direction 635-4 in the example 604.

As described above, the electronic device 101 may adjust the degree to which the direction indicated by the indicator 430 is changed according to the timing of identifying the movement of the input. Accordingly, as the input time interval increases, the user of the PC 310 may more precisely adjust the scan location.

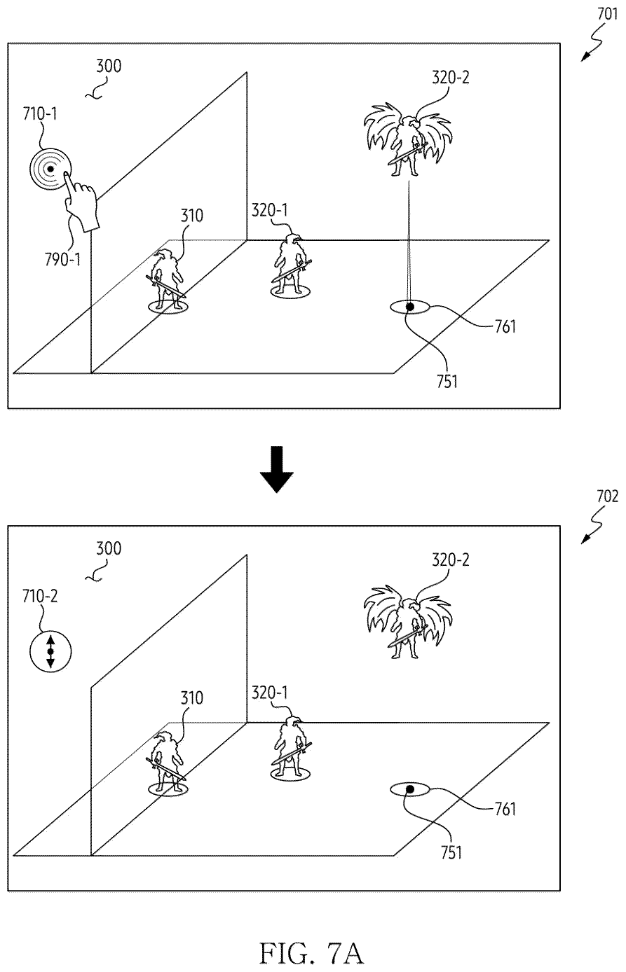

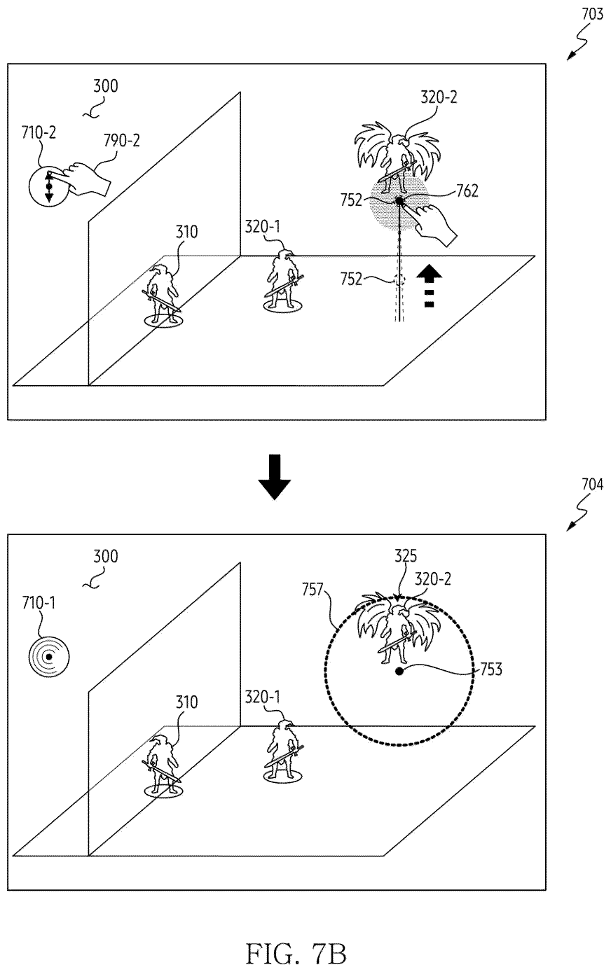

FIGS. 7A and 7B illustrate an example of a method of performing a three-dimensional scan based on inputs to buttons for a scan, according to an embodiment.

The scan may indicate an operation of identifying a target object from among one or more objects. For example, the three-dimensional scan may be referred to as the scan performed by considering not only a plane of the virtual space defined by some coordinates (e.g., x coordinate and y coordinate) but also an altitude of the virtual space defined by another coordinate (e.g., z coordinate).

The method of FIGS. 7A and 7B may be performed by the electronic device 101 of FIG. 1. For example, at least a portion of the method may be controlled by the processor 111 of the electronic device 101.

Referring to FIG. 7A, an electronic device 101 may display a screen 701. For example, the electronic device 101 may display the screen 701 through a display (e.g., the display 117 of FIG. 1).

According to an embodiment, the screen 701 may include a virtual space 300, a plurality of objects 320, PC 310 corresponding to a user of the electronic device 101, and a first button 710-1 for a scan. For example, the virtual space 300 may represent at least a portion of a virtual environment provided through the game service. For example, the plurality of objects 320 may include a first object 320-1 and a second object 320-2. However, this is only for convenience of explanation, and an embodiment of the present disclosure is not limited thereto. For example, the screen 701 may or may not include one object.

According to an embodiment, the first button 710-1 may represent a visual object for the scan. For example, the first button 710-1 may be formed in a circular shape. However, the embodiment of the present disclosure is not limited thereto. According to an embodiment, the electronic device 101 may obtain a first input 790-1 to the first button 710-1 in a state of displaying the screen 701 including the first button 710-1. For example, the first input 790-1 may include a drag input.

According to an embodiment, the electronic device 101 may identify a first location 751 on the plane of the virtual space 300 based on the first input 790-1 to the first button 710-1. For example, the electronic device 101 may move the first button 710-1 to the first location 751 based on the first input 790-1, which is the drag input to the first button 710-1. For example, the first location 751 may represent a point on the plane including a reference location corresponding to the PC 310. For example, an altitude value (e.g., z-coordinate) of the virtual space 300 for the point may correspond to an altitude value (e.g., z-coordinate) of the virtual space 300 for the PC 310. For example, the first location 751 may be used to identify a scan location.

According to an embodiment, the electronic device 101 may display a first visual object 761 on the first location 751. For example, the first visual object 761 may be displayed on a region including the first location 751. The region may be located on the plane. The first visual object 761 may be used to inform the user of the scan location. According to an embodiment, a location of the first visual object 761 may be changed based on movement (e.g., drag movement) of the first input 790-1. For example, the first visual object 761 may correspond to a location of the first button 710-1 changed according to the movement.

Referring to FIG. 7A, the electronic device 101 may display a screen 702 including a second button 710-2 based on identifying release of the first input 790-1. For example, the electronic device 101 may display the screen 702 through the display (e.g., the display 117 of FIG. 1). For example, the electronic device 101 may display the screen 702 changed from the screen 701 based on identifying the release of the first input 790-1. In FIG. 7A, it is exemplified that separate screens 701 and 702 are displayed, but this is only illustrated by dividing them into the separate screens 701 and 702 for convenience of explanation, and the screen 702 may be continuously displayed for the screen 701.

According to an embodiment, the electronic device 101 may display the second button 710-2 changed from the first button 710-1 based on identifying the release (e.g., a drop of the drag input) of the first input 710-1. According to an embodiment, the second button 710-2 may represent a circular visual object. For example, the second button 710-2 may display another image to distinguish it from the first button 710-1. The second button 710-2 is used to identify a scan location in an altitude direction of the virtual space 300, and may include the image representing a bidirectional arrow with respect to up/down. Alternatively, the first button 710-1 is used to identify a location (e.g., the first location 751) in a direction parallel to the plane of the virtual space 300, and may include an image including a plurality of circles. However, the above-described examples are merely examples for convenience of explanation, and embodiments of the present disclosure are not limited thereto.

Referring to FIG. 7B, the electronic device 101 may display a screen 703 including the second button 710-2. In FIGS. 7A and 7B, it is exemplified that separate screens 702 and 703 are displayed, but this is only illustrated by dividing them into the separate screens 702 and 703 for convenience of explanation, and the screen 703 may be continuously displayed for the screen 702.

According to an embodiment, the electronic device 101 may obtain a second input 790-2 to the second button 710-2 in a state of displaying the screen 703 including the second button 710-2. For example, the second input 790-2 may include a press input. According to an embodiment, the electronic device 101 may identify a second location 752 on the first location 751 of the virtual space 300 based on the second input 790-2 to the second button 710. For example, the second location 752 may represent a point on a vertical axis passing through the first location 751 of the plane of the virtual space 300. Coordinates x and y with respect to the second location 752 may correspond to coordinates x and y with respect to the first location 751. For example, the second location 752 may be referred to as the scan location.

According to an embodiment, the electronic device 101 may display a second visual object 762 above the first location 751. For example, the second visual object 762 may be displayed for a region including the second location 752. The region may be located in a space of the virtual space 300. The second visual object 762 may be used to inform the user of the scan location. According to an embodiment, a location of the second visual object 762 may be changed based on input time (e.g., press time) of the second input 790-2. For example, the second visual object 762 may start to be displayed in response to the electronic device 101 starting identifying the second input 790-2. For example, in response to identifying the second input 790-2 for a portion (e.g., an upper portion) of the second button 710-2, a location of the second visual object 762 may be moved in an upper direction. Alternatively, in response to identifying the second input 790-2 for another portion (e.g., a lower portion) of the second button 710-2, a location of the second visual object 762 may be moved in a lower direction. In addition, the second visual object 762 may be displayed in the space within the virtual space 300 above the first location 751 corresponding to the input time of the second input 790-2.

Referring to FIG. 7B, the electronic device 101 may display a screen 704 including the first button 710-1 based on identifying release of the second input 790-2. For example, the electronic device 101 may display the screen 704 through the display (e.g., the display 117 of FIG. 1). For example, the electronic device 101 may display the screen 704 changed from the screen 703 based on identifying the release of the second input 790-2. In FIG. 7B, it is exemplified that separate screens 703 and 704 are displayed, but this is only illustrated by dividing them into the separate screens 703 and 704 for convenience of explanation, and the screen 704 may be continuously displayed for the screen 703.

According to an embodiment, the electronic device 101 may identify a scan location 753 based on identifying the release of the second input 710-2. For example, the electronic device 101 may identify the second location 752 as the scan location 753 at a timing of identifying the release of the second input 710-2.

According to an embodiment, the electronic device 101 may display a visual effect based on the release of the second input 710-2. For example, the electronic device 101 may display the visual effect extending from the scan location 753 to a specified range 757. The visual effect may be used to identify a target object among the plurality of objects 320 in the virtual space 300. For example, the visual effect may extend from the scan location 753 to the specified range 757. For example, the specified range 757 may be identified based on a value set in the game service providing the virtual space 300, set by the user of the electronic device 101, or set according to stats (or skill) of the PC 310.

According to an embodiment, the electronic device 101 may perform a scan for identifying the target object based on a region where the visual effect is displayed. For example, the visual effect may be displayed sequentially extending from the scan location 753 to the specified range 757. The electronic device 101 may identify an object in the region of the visual effect that sequentially extends as the target object. In identifying the target object based on the visual effect, content of the screen 406 to the screen 408 of FIG. 4C may be applied substantially the same. For example, the electronic device 101 may identify the second object 320-2 as the target object among the plurality of objects 320. For example, the electronic device 101 may display an indicator 325 with respect to the second object 320-2 identified as the target object.

According to an embodiment, the visual effect may disappear after extending to the specified range 757. For example, the electronic device 101 may cease display of the visual effect, which starts extending from the scan location 753 and reaches the specified range 757. In addition, according to an embodiment, the electronic device 101 may display the first button 710-1 changed from the second button 710-2, with ceasing the display of the visual effect. Referring to the above, the electronic device 101 may identify the target object based on the scan location 753 based on identifying the release of the second input 790-2, and may cease the display of the visual effect.

According to an embodiment, the electronic device 101 may perform the operations of FIGS. 7A and 7B again in response to identifying another input to the first button 710-1 after ceasing the display.

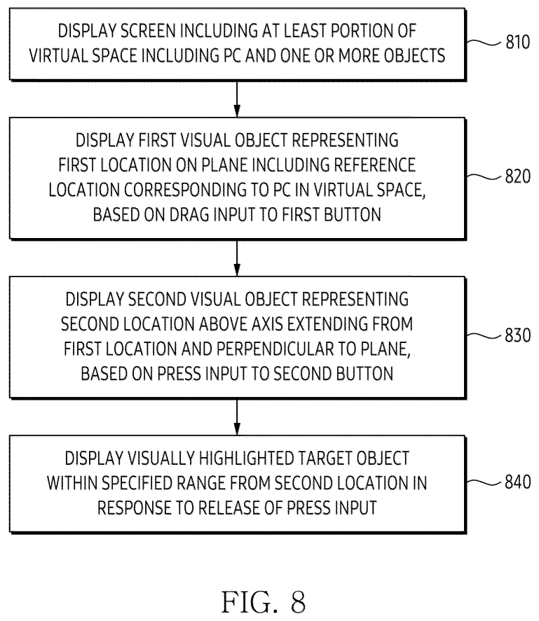

FIG. 8 illustrates an example of an operation flow for a method of performing a three-dimensional scan, based on inputs to buttons for a scan, according to an embodiment.

An electronic device of FIG. 8 may include the electronic device 101 of FIG. 1. At least one of operations of FIG. 8 may be performed by the electronic device 101 of FIG. 1. For example, at least one of the operations may be controlled by the processor 111 of FIG. 1. Each of the operations of FIG. 8 may be performed sequentially, but is not necessarily performed sequentially. For example, an order of each of the operations may be changed, and at least two operations may be performed in parallel.

In operation 810, the electronic device 101 may display a screen including at least a portion of a virtual space including PC and one or more objects. For example, the electronic device 101 may display the screen through a display (e.g., the display 117 of FIG. 1).

According to an embodiment, the screen may include the at least a portion of the virtual space, the PC corresponding to the user, the one or more objects, the virtual space, and a first button. In the above example, it is described that the screen includes the one or more objects, but an embodiment of the present disclosure is not limited thereto. For example, the screen may not include an object. For example, the screen may include the screens 701 to 704 of FIGS. 7A and 7B.

According to an embodiment, the first button may represent a visual object for the scan. The first button may be formed in a circular shape. However, the embodiment of the present disclosure is not limited thereto.

In operation 820, the electronic device 101 may display a first visual object representing a first location on a plane including a reference location corresponding to the PC in the virtual space, based on a drag input to the first button.

According to an embodiment, the electronic device 101 may obtain the drag input to the first button in a state of displaying the screen including the first button.

According to an embodiment, the electronic device 101 may identify the first location on the plane of the virtual space based on the drag input to the first button. For example, the first location may represent a point on the plane including the reference location. For example, an altitude value (e.g., z-coordinate) of the virtual space for the point may correspond to an altitude value (e.g., z-coordinate) of the virtual space for the PC. For example, the first location may be used to identify the scan location.

According to an embodiment, the electronic device 101 may display the first visual object on the first location. For example, the first visual object may be displayed for a region including the first location. The region may be located on the plane. The first visual object may be used to inform the user of the scan location. According to this configuration, a location of the first visual object may be changed based on movement of the first drag input.

In operation 830, the electronic device 101 may display a second visual object representing a second location above an axis extending from the first location and perpendicular to the plane, based on a press input to a second button. For example, the electronic device 101 may identify release of the drag input in a state of displaying the first visual object. For example, the electronic device 101 may display the screen including the second button changed from the first button in response to identifying the release of the first drag input.

According to an embodiment, the second button may represent a circular visual object. For example, the second button may display another image to distinguish it from the first button. The second button is used for identifying a scan location in an altitude direction of the virtual space, and may include the image representing a bidirectional arrow with respect to up/down. Alternatively, the first button is used to identify a location (e.g., the first location) in a direction parallel to the plane of the virtual space, and may include an image including a plurality of circles. However, the above-described examples are only examples for convenience of explanation, and embodiments of the present disclosure are not limited thereto.

According to an embodiment, the second visual object may be displayed for a region including the second location. The region may be located in a space of the virtual space. The second visual object may be used to inform the user of the scan location. According to an embodiment, a location of the second visual object may be changed based on input time of the press input. For example, the second visual object may start to be displayed in response to the electronic device 101 starting identifying the press input.

In operation 840, the electronic device 101 may display a visually highlighted target object within a specified range from the second location in response to release of the press input. For example, the electronic device 101 may identify the target object among the one or more objects in response to the release of the press input.

According to an embodiment, the electronic device 101 may identify the scan location based on identifying the release of the press input. For example, the electronic device 101 may identify the second location as the scan location at a timing of identifying the release of the press input.

According to an embodiment, the electronic device 101 may display a visual effect based on the release of the press input. For example, the electronic device 101 may display the visual effect extending from the scan location to the specified range. The visual effect may be used to identify the target object among the one or more objects in the virtual space. For example, the visual effect may extend from the scan location to the specified range. For example, the specified range may be identified based on a value set in the game service providing the virtual space, set by the user of the electronic device 101, or set according to the stats (or skill) of the PC.

According to an embodiment, the electronic device 101 may perform a scan for identifying the target object based on a region where the visual effect is displayed. For example, the electronic device 101 may identify an object in the region of the visual effect that sequentially extends as the target object. For example, the electronic device 101 may display an indicator indicating that the object identified as the target object is identified as the target object. For example, being identified as the target object may be understood as being targeted for the PC.

As described above, an electronic device may comprise a display. The electronic device may comprise a processor. The processor may be configured to display, via the display, a screen including a virtual space including a player character (PC) corresponding to a user of the electronic device and one or more objects. The screen may include a sphere-shaped button for a scan of a target object from among the one or more objects. The processor may be configured to display, in response to identifying initiation of a pan input on the button, a user interface (UI) for guiding the scan. The UI may include a sphere-shaped visual object surrounding the PC and an indicator indicating a first direction extending from a reference location corresponding to the PC in the virtual space. The processor may be configured to display, in a state of displaying the UI, based on movement of the pan input, the indicator indicating a second direction changed from the first direction. The processor may be configured to display, in response to identifying release of the pan input, the visually highlighted target object within a specified range from a scan location in the virtual space identified based on the second direction.

According to an embodiment, a direction of the indicator including the first direction and the second direction may be identified based on a coordinate on a vertical axis to a plane passing through a point on the plane in the virtual space including the reference location. The first direction may be identified based on a location of the pan input within the button at a timing identifying the initiation. The second direction may be identified based on a location of the pan input changed in accordance with the movement within the button.

According to an embodiment, the processor may be configured to display, in response to identifying the initiation of the pan input, the UI further including an icon for indicating the scan location on the indicator. The processor may be configured to, based on an input time interval of the pan input in a state of displaying the UI, display the icon having the scan location changed from the reference location.

According to an embodiment, the processor may be configured to display, in response to the release of the pan input, a visual effect extending from the scan location on the second direction.

According to an embodiment, the visual effect may be used for identifying the target object from among the one or more objects.

According to an embodiment, the processor may be configured to display the screen further including a bar-shaped visual object vertically extending from the scan location changed based on the input time interval to a point on a plane in the virtual space including the reference location.

According to an embodiment, the processor may be configured to display the screen further including a circular visual object including a point where the scan location changed based on the input time interval is orthogonally projected on a plane in the virtual space including the reference location.

According to an embodiment, the processor may be configured to, based on identifying a second timing after a specified time interval from a first timing identifying the initiation of the pan input, display the screen further including a circular progress bar which starts to be displayed from a point distant from a periphery of the button, and is displayed along the periphery. The circular progress bar may be changed based on a time length from the second timing until a third timing identifying the release.

According to an embodiment, the button may include a first guide line, a second guide line different from the first guide line, and a guide point representing an intersection of the first guide line and the second guide line. The visual object may include a third guide line and a fourth guide line different from the third guide line. The first guide line, the second guide line, and the guide point may be changed based on the movement of the pan input. The third guide line and the fourth guide line may be changed to correspond the indicator changed along the movement of the pan input.

According to an embodiment, the processor may be configured to display the screen further including another visual object representing a location of the pan input.

According to an embodiment, the processor may be configured to display, before identifying the initiation of the pan input, the screen including the button with a first shape. The processor may be configured to display, in response to identifying the initiation of the pan input, the screen including the button with a second shape changed from the first shape. The processor may be configured to display, in response to identifying the release of the pan input, the screen including the button with the first shape changed from the second shape.

According to an embodiment, the processor may be configured to identify a third direction changed from the first direction during a first time interval. The processor may be configured to identify the second direction changed from the third direction during a second time interval after the first time interval. When a length of the first time interval corresponds to a length of the second time interval, an amount of change between the third direction and the first direction may be greater than an amount of change between the third direction and the second direction.

As described above, a method executed by an electronic device may comprise displaying, via a display of the electronic device, a screen including a virtual space including a player character (PC) corresponding to a user of the electronic device and one or more objects. The screen may include a sphere-shaped button for a scan of a target object from among the one or more objects. The method may comprise displaying, in response to identifying initiation of a pan input on the button, a user interface (UI) for guiding the scan. The UI may include a sphere-shaped visual object surrounding the PC and an indicator indicating a first direction extending from a reference location corresponding to the PC in the virtual space. The method may comprise displaying, in a state of displaying the UI, based on movement of the pan input, the indicator indicating a second direction changed from the first direction. The method may comprise displaying, in response to identifying release of the pan input, the visually highlighted target object within a specified range from a scan location in the virtual space identified based on the second direction.

According to an embodiment, a direction of the indicator including the first direction and the second direction may be identified based on a coordinate on a vertical axis to the plane passing through a point on the plane in the virtual space including the reference location. The first direction may be identified based on a location of the pan input within the button at a timing identifying the initiation. The second direction may be identified based on a location of the pan input changed in accordance with the movement within the button.

According to an embodiment, the method may comprise displaying, in response to identifying the initiation of the pan input, the UI further including an icon for indicating the scan location on the indicator. The method may comprise, based on an input time interval of the pan input in a state of displaying the UI, displaying the icon having the scan location changed from the reference location.

According to an embodiment, the method may comprise displaying, in response to the release of the pan input, a visual effect extending from the scan location on the second direction.

According to an embodiment, the visual effect may be used for identifying the target object from among the one or more objects.

According to an embodiment, the method may comprise, based on identifying a second timing after a specified time interval from a first timing identifying the initiation of the pan input, displaying the screen further including a circular progress bar which starts to be displayed from a point distant from a periphery of the button, and is displayed along the periphery. The circular progress bar may be changed based on a time length from the second timing until a third timing identifying the release.

As described above, in a computer-readable storage medium storing one or more programs, the one or more programs may be configured to comprise instructions which, when executed by a processor of an electronic device, cause the electronic device to display, via a display of the electronic device, a screen including a virtual space including a player character (PC) corresponding to a user of the electronic device and one or more objects. The screen may include a sphere-shaped button for a scan of a target object from among the one or more objects. The one or more programs may be configured to comprise instructions which, when executed by the processor of the electronic device, cause the electronic device to display, in response to identifying initiation of a pan input on the button, a user interface (UI) for guiding the scan. The UI may include a sphere-shaped visual object surrounding the PC and an indicator indicating a first direction extending from a reference location corresponding to the PC in the virtual space. The one or more programs may be configured to comprise instructions which, when executed by the processor of the electronic device, cause the electronic device to display, in a state of displaying the UI, based on movement of the pan input, the indicator indicating a second direction changed from the first direction. The one or more programs may be configured to comprise instructions which, when executed by the processor of the electronic device, cause the electronic device to display, in response to identifying release of the pan input, the visually highlighted target object within the specified range from a scan location in the virtual space identified based on the second direction.

As described above, an electronic device may comprise a display. The electronic device may comprise a processor. The processor may be configured to display, via the display, a player character (PC) corresponding to a user of the electronic device and virtual space including one or more objects. The screen may include a first button for a scan of a target object from among the one or more objects. The processor may be configured to display, based on a drag input on the first button, a first visual object representing a first location on a plane including a reference location corresponding to the PC in the virtual space. The processor may be configured to display, in a state where the first visual object is displayed, in response to release of the drag input, based on a press input on a second button changed from the first button, a second visual object representing a second location above an axis which extends from the first location and is perpendicular to the plane. The processor may be configured to display, in response to release of the press input, the visually highlighted target object within a specified range from the second location.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later. According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
at least one memory configured to store at least one program;
at least one processor configured to operate as instructed by the program,
wherein the program is configured to cause the at least one processor to:
display, via the display, a screen including a virtual space including a player character (PC) corresponding to a user of the electronic device and at least one object,
wherein the screen includes a sphere-shaped button for scanning a target object from the at least one object;
display, based on detecting a pan input on the sphere-shaped button, a user interface (UI) for guiding the scanning,
wherein the UI includes a sphere-shaped visual object surrounding the PC and an indicator indicating a first direction extending from a reference location corresponding to the PC in the virtual space;
display, based on movement of the pan input while the UI is displayed, the indicator indicating a second direction changed from the first direction; and
display, based on detecting release of the pan input, at least one visually highlighted target object within a range from a scan location in the virtual space,
wherein the scan location is identified based on the second direction.

2. The electronic device of claim 1, wherein a direction of the indicator, including the first direction and the second direction, is defined based on:
a first coordinate of a plane in the virtual space, the plane including the reference location; and
a second coordinate on a vertical axis to the plane;
wherein the first direction is identified based on a location of the pan input within the sphere-shaped button at a timing of detecting the pan input; and
wherein the second direction is identified based on a changed location of the pan input within the sphere-shaped button resulting from the movement.

3. The electronic device of claim 1, wherein the program is further configured to cause the at least one processor to:
display, based on detecting the pan input, the UI further including an icon, the icon indicating the scan location on the indicator; and
display, based on an input time interval of the pan input while the UI is displayed, the icon with the scan location that is changed from the reference location.

4. The electronic device of claim 3, wherein the program is further configured to cause the at least one processor to:
display, based on detecting the release of the pan input, a visual effect extending from the scan location along the second direction to the range.

5. The electronic device of claim 4, wherein the visual effect is configured to identify the target object from among the at least one object.

6. The electronic device of claim 3,
wherein the screen further includes a bar-shaped visual object, the bar-shaped visual object extending vertically from the scan location to a point on a plane in the virtual space, the plane including the reference location,
wherein the scan location is changed based on the input time interval.

7. The electronic device of claim 3,
wherein the screen further includes a circular visual object that includes a point on the plane in the virtual space,
wherein the point represents an orthogonal projection of the scan location onto the plane, the plane including the reference location,
wherein the scan location is changed based on the input time interval.

8. The electronic device of claim 1, wherein the program is further configured to cause the at least one processor to:
based on identifying a second timing after a time interval from a first timing detecting the pan input, display a circular progress bar on the screen, the circular progress bar starting from a point distant from a periphery of the sphere-shaped button, and extending along the periphery; and
wherein the circular progress bar is changed based on a time length from the second timing to a third timing, the third timing corresponding to detecting the release of the pan input.

9. The electronic device of claim 1, wherein the sphere-shaped button includes a first guide line, a second guide line different from the first guide line, and a guide point representing an intersection of the first guide line and the second guide line, and
wherein the sphere-shaped visual object includes a third guide line and a fourth guide line different from the third guide line,
wherein the first guide line, the second guide line, and the guide point are changed based on the movement of the pan input, and
wherein the third guide line and the fourth guide line are changed to correspond with the indicator as the indicator changes based on the movement of the pan input.

10. The electronic device of claim 1,
wherein the screen further includes an additional visual object representing a location of the pan input.

11. The electronic device of claim 1, wherein the program is further configured to cause the at least one processor to:
display, before detecting the pan input, the screen including the sphere-shaped button with a first shape;
display, based on detecting the pan input, the screen including the sphere-shaped button with a second shape that is changed from the first shape; and
display, based on detecting the release of the pan input, the screen including the sphere-shaped button with the first shape that is changed from the second shape.

12. The electronic device of claim 1, wherein the processor is configured to:
identify a third direction changed from the first direction during a first time interval; and
identify the second direction changed from the third direction during a second time interval after the first time interval,
wherein, based on a length of the first time interval being equal to a length of the second time interval, an amount of change between the third direction and the first direction is greater than an amount of change between the third direction and the second direction.

13. A method executed by an electronic device, comprising:
displaying, via a display, a screen including a virtual space including a player character (PC) corresponding to a user of the electronic device and at least one object,
wherein the screen includes a sphere-shaped button for scanning a target object from the at least one object;
displaying, based on detecting a pan input on the sphere-shaped button, a user interface (UI) for guiding the scanning,
wherein the UI includes a sphere-shaped visual object surrounding the PC and an indicator indicating a first direction extending from a reference location corresponding to the PC in the virtual space;
displaying, based on movement of the pan input while the UI is displayed, the indicator indicating a second direction changed from the first direction; and
displaying, based on detecting release of the pan input, at least one visually highlighted target object within a range from a scan location in the virtual space,
wherein the scan location is identified based on the second direction.

14. The method of claim 13, wherein a direction of the indicator, including the first direction and the second direction, is defined based on:
a first coordinate of a plane in the virtual space, the plane including the reference location; and
a second coordinate on a vertical axis to the plane;
wherein the first direction is identified based on a location of the pan input within the sphere-shaped button at a timing of detecting the pan input; and
wherein the second direction is identified based on a changed location of the pan input within the sphere-shaped button resulting from the movement.

15. The method of claim 13, comprising:
displaying, based on detecting the pan input, the UI further including an icon, the icon indicating the scan location on the indicator; and
displaying, based on an input time interval of the pan input while the UI is displayed, the icon with the scan location that is changed from the reference location.

16. The method of claim 15, comprising:
displaying, based on detecting the release of the pan input, a visual effect extending from the scan location along the second direction to the range.

17. The method of claim 16, wherein the visual effect identifies the target object from the at least one object.

18. The method of claim 13,
wherein the screen further includes a bar-shaped visual object, the bar-shaped visual object extending vertically from the scan location to a point on a plane in the virtual space, the plane including the reference location,
wherein the scan location is changed based on the input time interval.

19. The method of claim 13,
wherein the screen further includes a circular visual object that includes a point on the plane in the virtual space,
wherein the point represents an orthogonal projection of the scan location onto the plane, the plane including the reference location,
wherein the scan location is changed based on the input time interval.

20. A computer-readable storage medium storing one or more programs, wherein the one or more programs comprise instructions which, when executed by a processor of an electronic device, cause the electronic device to:
display, via a display, a screen including a virtual space including a player character (PC) corresponding to a user of the electronic device and at least one object,
wherein the screen includes a sphere-shaped button for scanning a target object from the at least one object;
display, based on detecting a pan input on the sphere-shaped button, a user interface (UI) for guiding the scanning,
wherein the UI includes a sphere-shaped visual object surrounding the PC and an indicator indicating a first direction extending from a reference location corresponding to the PC in the virtual space;
display, based on movement of the pan input while the UI is displayed, the indicator indicating a second direction changed from the first direction; and
display, based on detecting release of the pan input, at least one visually highlighted target object within a range from a scan location in the virtual space,
wherein the scan location is identified based on the second direction.
